(19) United States
(12) Patent Application Publication
(10) Pub. No.: US 2026/0278975 A1
(43) Pub. Date: Sep. 17, 2026

(54) VIRTUAL ELEMENT DISPLAY METHOD AND APPARATUS, DEVICE, MEDIUM, AND PROGRAM PRODUCT

(71) Applicant: Tencent Technology (Shenzhen) Company Limited, Shenzhen (CN)

(72) Inventors: Cong Tian, Shenzhen (CN); Siya Zhu, Shenzhen (CN)

(21) Appl. No.: 19/669,685

(22) Filed: May 6, 2026

Related U.S. Application Data
(63) Continuation of application No. PCT/CN2025/082990, filed on Mar. 17, 2025.

(30) Foreign Application Priority Data
Apr. 26, 2024 (CN) 202410520276.6

(51) Int. Cl. G06T 19/20; G06F 3/04845; G06F 3/04847; G06T 13/20

(52) U.S. Cl. CPC G06T 19/20; G06F 3/04845; G06F 3/04847; G06T 13/20; G06T 2200/24; G06T 2219/2016

(57) ABSTRACT

The present application provides a virtual element display method performed by a computer device. The method includes: displaying a virtual scene including a first virtual element and an editing control in a user interface; in response to a first trigger operation on the editing control, rendering a first transformation animation of the first virtual element after the first trigger operation in which the first virtual element is transformed by a preset transformation amplitude; and in response to a second trigger operation on the editing control, rendering a second transformation animation of the first virtual element in real time in tandem with the second trigger operation in which the first virtual element is transformed continuously corresponding to the second trigger operation. In this way, transformation control flexibility improves operation efficiency of the user interface by a user for controlling the virtual element to be transformed, and reduces waste of computer resources.

### CROSS-REFERENCE TO RELATED APPLICATIONS

This application is a continuation application of PCT Patent Application No. PCT/CN2025/082990, entitled “VIRTUAL ELEMENT DISPLAY METHOD AND APPARATUS, DEVICE, MEDIUM, AND PROGRAM PRODUCT” filed on Mar. 17, 2025, which claims priority to Chinese Patent Application No. 202410520276.6, entitled “VIRTUAL ELEMENT DISPLAY METHOD AND APPARATUS, DEVICE, MEDIUM, AND PROGRAM PRODUCT” filed on Apr. 26, 2024, all of which are incorporated herein by reference in their entirety.

### FIELD OF THE TECHNOLOGY

Embodiments of this application relate to the field of human-computer interaction, and to a virtual element display method and apparatus, a device, a medium, and a program product.

### BACKGROUND OF THE DISCLOSURE

In a game having a construction mode, when constructing a customized scene, a user usually needs to set a placement state of a placed article, for example, adjust a current placement angle of the placed article in a virtual scene.

### SUMMARY

Embodiments of this application provide a virtual element display method and apparatus, a device, a medium, and a program product. Technical solutions are as follows:

According to an aspect, a virtual element display method is performed by a computer device, and the method includes:
displaying a virtual scene including a first virtual element and an editing control in a user interface, the editing control being configured to edit the first virtual element in the virtual scene;
in response to a first trigger operation on the editing control, rendering a first transformation animation of the first virtual element after the first trigger operation, the first transformation animation comprising an animation effect that the first virtual element is transformed by a preset transformation amplitude; and
in response to a second trigger operation on the editing control, rendering a second transformation animation of the first virtual element in real time in tandem with the second trigger operation, the second transformation animation comprising an animation effect that the first virtual element is transformed continuously corresponding to the second trigger operation, and the first trigger operation being different from the second trigger operation.

According to another aspect, a computer device is provided, and includes a processor and a memory, the memory having at least one instruction, at least one program, a code set, or an instruction set stored therein, the at least one instruction, the at least one program, the code set, or the instruction set being loaded and executed by the processor and causing the computer device to implement any virtual element display method described above.

According to another aspect, a non-transitory computer-readable storage medium is provided, and has at least one instruction, at least one program, a code set, or an instruction set stored therein, the at least one instruction, the at least one program, the code set, or the instruction set being loaded and executed by a processor of a computer device and causing the computer device to implement any virtual element display method described above.

The technical solutions provided in the embodiments of this application include at least the following beneficial effects:

A user may perform customized editing on a virtual element in a virtual scene by triggering an editing control. When a first trigger operation is performed on the editing control, the virtual element is transformed by a preset transformation amplitude, and the user does not need to manually set or adjust a transformation amplitude, to implement rapid transformation control on the virtual element. When a second trigger operation is performed on the editing control, the virtual element is transformed following the second trigger operation by a dynamic transformation amplitude corresponding to the second trigger operation. Therefore, the second trigger operation is controlled, so that the transformation amplitude of the virtual element can be precisely controlled, to implement precise transformation control on the virtual element. Therefore, rapid transformation control and precise transformation control on the virtual element are integrated on one editing control, so that the user can complete a plurality of types of transformation control on the virtual element on one editing control. This improves flexibility of performing transformation control on the virtual element, and simplifies operations for implementing the plurality of types of transformation control, thereby improving operation efficiency of the user for controlling the virtual element to be transformed, and reducing waste of computer operation resources.

### BRIEF DESCRIPTION OF THE DRAWINGS

FIG. 1 is a schematic diagram of a computer system according to an exemplary embodiment of this application.

FIG. 2 is a schematic diagram of a virtual element display method according to an exemplary embodiment of this application.

FIG. 3 is a flowchart of a virtual element display method according to an exemplary embodiment of this application.

FIG. 4 is a flowchart of a virtual element display method according to another exemplary embodiment of this application.

FIG. 5 is a schematic diagram of a first trigger operation according to an exemplary embodiment of this application.

FIG. 6 is a schematic diagram of a rotation scale according to an exemplary embodiment of this application.

FIG. 7 is a schematic diagram of a counterclockwise rotation scale according to an exemplary embodiment of this application.

FIG. 8 is a schematic diagram of a clockwise rotation scale according to an exemplary embodiment of this application.

FIG. 9 is a schematic diagram of a horizontal coordinate distance according to an exemplary embodiment of this application.

FIG. 10 is a schematic diagram of a second trigger operation according to an exemplary embodiment of this application.

FIG. 11 is an implementation flowchart of a rotation control according to an exemplary embodiment of this application.

FIG. 12 is a flowchart of a virtual element display method according to still another exemplary embodiment of this application.

FIG. 13 is a schematic diagram of a rotation scale according to another exemplary embodiment of this application.

FIG. 14 is an implementation flowchart of a rotation control according to another exemplary embodiment of this application.

FIG. 15 is a structural block diagram of a virtual element display apparatus according to an exemplary embodiment of this application.

FIG. 16 is a structural block diagram of a computer device according to an exemplary embodiment of this application.

### DESCRIPTION OF EMBODIMENTS

In this application, before and during acquisition of relevant data of a user, a prompt interface or a pop-up window may be displayed, or speech prompt information may be outputted. The prompt interface, the pop-up window, or the speech prompt information is configured for prompting the user that relevant data of the user is currently being acquired. In this way, in this application, only after a confirmation operation performed by the user for the prompt interface or the pop-up window is obtained, the relevant steps of obtaining the relevant data of the user start to be performed. Otherwise (in other words, when the confirmation operation performed by the user for the prompt interface or the pop-up window is not obtained), the relevant steps of obtaining the relevant data of the user are ended, that is, the relevant data of the user is not obtained. In other words, all user data acquired in this application is acquired with user consent and authorization, and acquisition, use, and processing of relevant user data need to comply with relevant laws, regulations, and standards of relevant countries and regions.

First, terms in the embodiments of this application are briefly described.

Virtual scene: The virtual scene is displayed or provided when a client is run on a terminal. The virtual scene may be a simulated world of a real world, or may be a semi-simulated semi-fictional three-dimensional world, or may be an entirely fictional three-dimensional world. The virtual scene may be any one of a two-dimensional virtual scene, a 2.5-dimensional virtual scene, and a three-dimensional virtual scene.

In response to: It is used to represent a condition or status on which one or more operations to be performed depend. When the condition or status is met, the one or more operations may be performed immediately or after a set delay. Unless explicitly stated, there is no limitation on the order in which the plurality of operations are performed.

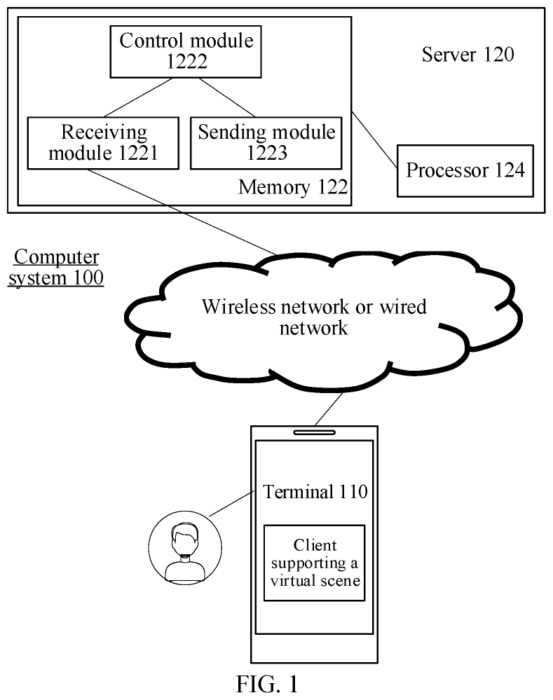

FIG. 1 is a structural block diagram of a computer system 100 according to an exemplary embodiment of this application. The computer system 100 may be implemented as a system architecture of a virtual element display method. The computer system 100 includes a terminal 110 and a server 120.

The terminal 110 may be an electronic device like a mobile phone, a tablet computer, an in-vehicle terminal (car machine), a wearable device, or a personal computer (PC). A client running a target application may be installed on the terminal 110. The target application may be any one of a virtual reality (VR) client, an augmented reality (AR) program, a three-dimensional map program, a virtual reality game, an augmented reality game, a first-person shooting (FPS) game, a third-person shooting (TPS) game, a multiplayer online battle arena (MOBA) game, a simulation game (SLG), a party casual game, and a construction game. In addition, a form of the target application is not limited in this application. The target application includes, but not limited to, an application (App) installed on the terminal 110, an applet, or the like, and may also be in a form of a web page.

The terminal 110 is connected to the server 120 by using a wireless network or a wired network.

The server 120 can be an independent physical server, or can be a server cluster or a distributed system formed by a plurality of physical servers, or can be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform.

A cloud technology is a hosting technology that unifies a series of resources such as hardware, software, and networks in a wide area network or a local area network to implement computing, storage, processing, and sharing of data. The cloud technology is a collective name of a network technology, an information technology, an integration technology, a management platform technology, an application technology, and the like based on an application of a cloud computing business mode, and may form a resource pool, which is used as required, and is flexible and convenient. The cloud computing technology becomes an important support. A background service of a technical network system requires a large amount of computing and storage resources, such as video websites, image websites, and more portal websites. As the Internet industry is advanced and applied, each article may have its own identifier in the future and needs to be transmitted to a background system for logical processing. Data at different levels is separately processed, and data in various industries requires strong system support, which can only be implemented through cloud computing. In one embodiment, the server 120 may alternatively be implemented as a node in a blockchain system.

For example, the server 120 includes a processor 124 and a memory 122, and the memory 122 further includes a receiving module 1221, a control module 1222, and a sending module 1223. The receiving module 1221 is configured to receive a request sent by the terminal 110. The control module 1222 is configured to control rendering of a virtual scene image. The sending module 1223 is configured to send a response to the terminal 110. The server 120 is configured to provide a back-end service to the terminal 110.

In one embodiment, the server 120 is responsible for primary computing work, and the terminal 110 is responsible for secondary computing work; or the server 120 is responsible for secondary computing work, and the terminal 110 is responsible for primary computing work; or the server 120 and the terminal 110 perform collaborative computing by using a distributed computing architecture between each other.

In the virtual element display method provided in the embodiments of this application, operations may be performed by a computer device. The computer device is an electronic device having data calculation, processing, and storage capabilities. By using an implementation environment of the solution shown in FIG. 1 as an example, the terminal 110 may perform the virtual element display method (for example, the target application that is installed on and runs on the terminal 110 performs the virtual element display method), the server 120 may perform the virtual element display method, or the terminal 110 and the server 120 cooperate to perform the virtual element display method. This is not limited in this application.

A person skilled in the art may learn that there may be more or fewer terminals 110. For example, there may be only one terminal 110, or there may be dozens or hundreds of terminals 110 or more. The quantity and the device type of the terminals 110 are not limited in the embodiments of this application.

In a game having a construction mode, when constructing a customized scene, a user usually needs to set a placement state of a placed article, for example, adjust a current placement angle of the placed article in a virtual scene. In a related technology, if angle adjustment needs to be performed on a placed article, the placed article may be selected and a rotation control button may be taped on. After the rotation control button is taped on, rotation transformation by a fixed angle is performed on the placed article. However, in the manner of transforming the placed article by the fixed angle by taping on the rotation control button, an angle adjustment operation lacks flexibility, and the user needs to frequently tap on the button to adjust an angle to achieve an expected placement effect. Consequently, operation efficiency of the user is low, and computer operation resources are wasted.

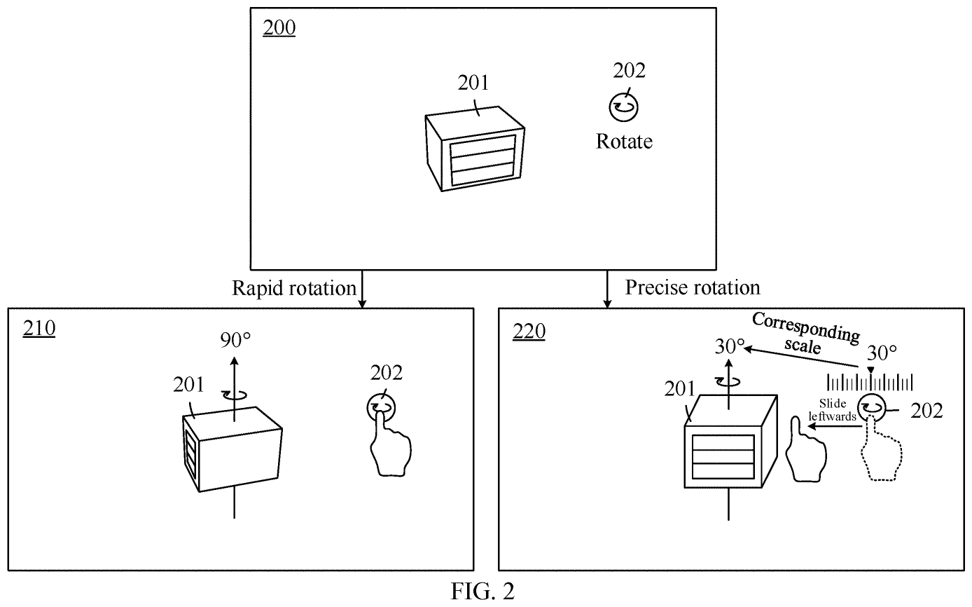

Based on this, an embodiment of this application provides a virtual element display method. An example in which transformation control in this application is implemented as rotation transformation is used below for description. FIG. 2 is a schematic diagram of a virtual element display method according to an exemplary embodiment of this application. An example in which the method is applied to a computer device is used for description. The computer device may be the terminal 110 shown in FIG. 1. The method includes the following operation 1 to operation 3.

Operation 1: Display a first virtual element 201 in a virtual scene, and display a rotation control 202.

For example, a target application having a construction mode runs on the computer device. After the construction mode of the target application is entered, the virtual scene is displayed on an interface 200. A user may add the first virtual element 201 to the virtual scene, and perform customized editing on the first virtual element 201, for example, a rotation operation, a movement operation, or a zoom operation.

The rotation operation is used as an example for description. In a state in which the first virtual element 201 is selected, a rotation control 202 may be displayed on the interface 200. The rotation control 202 is configured to control the first virtual element 201 to be rotated in a virtual scene 200.

Operation 2: Display a first rotation animation of the first virtual element 201 in response to a tap operation on the rotation control 202.

For example, the tap operation is a one-tap operation. After the user one-taps on the rotation control 202, the computer device displays the first rotation animation on an interface 210 in response to the tap operation. The first rotation animation is an animation effect that the first virtual element 201 is rotated by a preset rotation angle in a preset rotation direction, for example, the first virtual element 201 is rotated by 90° clockwise, to implement rapid rotation on the first virtual element.

Operation 3: After a long-press operation on the rotation control 202 is detected, in response to a slide operation joining the long-press operation, display a second rotation animation of the first virtual element 201 in real time in tandem with the slide operation.

The long-press operation is a press operation on the rotation control 202, and a position of the press operation is not changed. The slide operation joining the long-press operation is a slide operation performed in preset duration after the long-press operation is performed.

For example, after the long-press operation is performed, a finger is loosened, and the slide operation is performed in the preset duration after the finger is loosened.

For example, after the long-press operation is performed, a press state is kept unchanged, and the slide operation is continued to be performed. When a position of a press operation is not changed, the press operation is a long-press operation. When the position of the press operation is moved, the press operation is a slide operation. For example, if the user performs a press operation on the rotation control 202 and keeps a position of the press operation unchanged, it is considered that the user performs a long-press operation on the rotation control 202. If the user moves the press operation when keeping a press state unchanged, it is considered that the user performs a slide operation joining the long-press operation.

For example, if the first virtual element 201 needs to be precisely rotated, the user may long-press the rotation control 202. In this case, on an interface 220, a scale and a rotation degree number are displayed on the top of the rotation control 202. The rotation control 202 is long-pressed and slid leftwards, to control the first virtual element 201 to be rotated clockwise. The rotation control 202 is long-pressed and slid rightwards, to control the first virtual element 201 to be rotated counterclockwise. Rotation is performed by using 1° as a unit, and rotation is performed based on the rotation degree number (for example, 30°) displayed on the scale.

In conclusion, according to the virtual element display method provided in this embodiment of this application, rapid rotation and precise rotation on a virtual element are integrated on one rotation control, so that a user can complete a plurality of rotation operations on the virtual element on one rotation control of one interface. In this way, rotation operation flexibility is high, and operations for implementing the plurality of rotation operations are simplified, thereby improving operation efficiency of the user for controlling the virtual element to be rotated, and reducing waste of computer operation resources.

The following describes a procedure of the virtual element display method provided in this application.

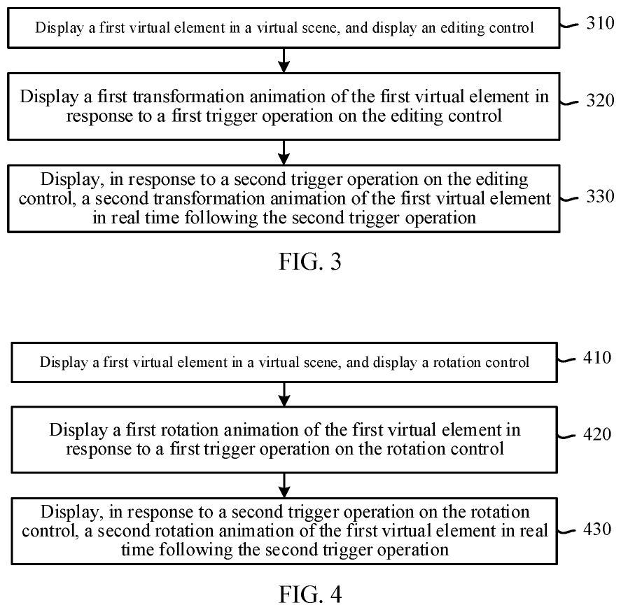

FIG. 3 is a flowchart of a virtual element display method according to an exemplary embodiment of this application. An example in which the method is applied to a computer device is used for description. The computer device may be the terminal 110 shown in FIG. 1. The method includes operation 310 to operation 330.

Operation 310: Display a first virtual element in a virtual scene, and display an editing control.

In some embodiments, the virtual scene is a virtual scene in which customized editing may be performed.

For example, a target application runs on the computer device, and the target application provides a function of creating virtual content in a customized manner, for example, creating a new virtual scene, or editing or modifying display content in an existing virtual scene.

In one embodiment, a scene editing interface is displayed. The scene editing interface includes the first virtual element in the virtual scene and the editing control.

For example, the scene editing interface may be a game level (for example, a shooting game, a puzzle game, a music game, a survival game, a car racing game, or a racing game) editing interface, a virtual item editing interface, a virtual character editing interface, a customized house editing interface, a virtual building editing interface, or the like. This is not limited in the embodiments of this application.

The first virtual element is an element on which customized editing can be performed in the virtual scene. There may be one or more first virtual elements. This is not limited in the embodiments of this application.

For example, the first virtual element may be any editable display element in the virtual scene, for example, a character, an item, or a scene (for example, elements such as various terrains, buildings, and vegetation).

In some embodiments, the first virtual element is an element added to the virtual scene by a user. In one embodiment, in response to an addition operation on the first virtual element, the first virtual element is displayed in the virtual scene, and the editing control is displayed.

For example, the addition operation may be an operation of dragging a template element of the first virtual element to the virtual scene. After the dragging is completed, the first virtual element is displayed in the virtual scene based on the template element. Alternatively, the addition operation may be a trigger operation on an element addition control of the first virtual element. The element addition control of the first virtual element is displayed on the scene editing interface, and the first virtual element is displayed in the virtual scene in response to the trigger operation on the element addition control. An operation of adding a virtual element to the virtual scene is not limited in the embodiments of this application. After the first virtual element is added, the user may edit and modify the first virtual element by using the editing control.

In the foregoing embodiment, the first virtual element in the virtual scene and the editing control are displayed in response to the addition operation on the first virtual element, to edit and modify the first virtual element, thereby quickly creating the first virtual element, and improving efficiency of creating the first virtual element.

In some embodiments, the first virtual element may be an element existing in the virtual scene. For example, on the scene editing interface, a to-be-edited virtual scene includes a default virtual element, and the user may directly edit and modify the default virtual element. The default virtual element is an element existing in the to-be-edited virtual scene, rather than an element manually added to the virtual scene by the user.

The editing control is configured to edit the first virtual element in the virtual scene, that is, perform customized editing on the first virtual element based on a user operation.

For example, the editing control includes at least one of a rotation control, a zoom control, a position adjustment control, a transparency adjustment control, a level adjustment control, and the like. This is not limited in the embodiments of this application. The rotation control is configured to control a virtual element to be rotated, to change a rotation angle of the virtual element in the virtual scene. The zoom control is configured to adjust a zoom ratio of the virtual element, to achieve a zoom-in or zoom-out effect. The position adjustment control is configured to adjust position coordinates of the virtual element in the virtual scene. The transparency adjustment control is configured to adjust transparency of the virtual element. The level adjustment control is configured to control a display level of the virtual element in the virtual scene, to determine a blocking relationship between elements.

In one embodiment, the editing control of the first virtual element is displayed when the first virtual element is selected. For example, when the first virtual element is selected, the computer device displays, based on a type or an attribute of the first virtual element, the editing control matching the type or the attribute of the first virtual element. The user may edit the first virtual element by using the editing control.

In one embodiment, one editing control corresponds to one editing operation. For example, the rotation control corresponds to a rotation operation, and the position adjustment control corresponds to a position adjustment operation.

Operation 320: Display a first transformation animation of the first virtual element in response to a first trigger operation on the editing control. In other words, the computer device renders the first transformation animation in response to the first trigger operation.

The first transformation animation includes an animation effect that the first virtual element is transformed by a preset transformation amplitude. For example, the fact that the first virtual element is transformed by the preset transformation amplitude means that the first virtual element is transformed by a fixed transformation amplitude.

In one embodiment, the preset transformation amplitude may include at least one of a preset rotation angle, a preset zoom ratio, a preset distance, preset transparency, and a preset level. This is not limited in the embodiments of this application.

In one embodiment, the first trigger operation includes at least one of a tap operation (for example, a one-tap operation or a double-tap operation), a long-press operation, a slide operation, a multi-point touch operation (that is, a touch operation implemented by using a plurality of fingers), a device shaking operation (that is, an operation triggered by shaking a computer device), and the like. This is not limited in the embodiments of this application. In one embodiment, a case of displaying the first transformation animation includes at least one of the following cases:

### 1. Display the First Transformation Animation in Response to a Tap Operation on the Editing Control.

For example, the editing control is one-tapped on or double-tapped on, to control the first virtual element to be transformed by the preset transformation amplitude. For example, the first virtual element is rotated by the preset rotation angle in a preset direction; transparency of the first virtual element is reduced or increased by the preset transparency, or is adjusted to the preset transparency; the first virtual element is moved by a preset distance in a preset direction; a zoom ratio of the first virtual element is reduced or increased by the preset zoom ratio, or is adjusted to the preset zoom ratio; and a level of the first virtual element is adjusted upwards or downwards by the preset level, or is adjusted to the preset level.

### 2. Display the First Transformation Animation in Response to a Double-Tap Operation on the Editing Control.

In some embodiments, the virtual scene includes a second virtual element, and the first virtual element and the second virtual element have an association relationship. The first transformation animation includes an animation effect that the first virtual element and the second virtual element are synchronously transformed by the preset transformation amplitude.

For example, the first virtual element and the second virtual element are elements in a same editing group. If any virtual element in the same editing group is transformed, and another virtual element in the group is correspondingly transformed. Alternatively, the first virtual element is a parent element of the second virtual element, and the second virtual element is a child element (or a sub-element) of the first virtual element. When the parent element is transformed, the child element may be correspondingly transformed following the parent element.

In the foregoing embodiment, the double-tap operation is used as the first trigger operation, to implement batch transformation on the virtual element, thereby improving efficiency of editing the virtual element.

The foregoing examples of displaying the first transformation animation are only for exemplary description, and are not limited in the embodiments of this application.

In one embodiment, the preset transformation amplitude configured for the first trigger operation is default,
or the preset transformation amplitude configured for the first trigger operation is preset by the user on the scene editing interface.

For example, a first setting area is displayed, the first setting area being configured for configuring a transformation amplitude corresponding to the first trigger operation; and the preset transformation amplitude is configured for the first trigger operation in response to an amplitude configuration operation on the first trigger operation in the first setting area. The amplitude configuration operation is configured for configuring the preset transformation amplitude for the first trigger operation.

For example, before the first trigger operation is detected, the first setting area of the first virtual element is displayed on the scene editing interface. The first setting area is configured for configuring the preset transformation amplitude of the first virtual element when the first trigger operation is triggered. In one embodiment, an amplitude entry box or an amplitude list is displayed in the first setting area, and the preset transformation amplitude is entered in the amplitude entry box or the preset transformation amplitude is selected from the amplitude list, so that configuration of the preset transformation amplitude corresponding to the first trigger operation is completed.

In the foregoing embodiment, the first setting area is provided, so that the user may configure, before performing the first trigger operation, the preset transformation amplitude corresponding to the first trigger operation, that is, the user is allowed to customize the preset transformation amplitude, to improve flexibility of controlling, by using the first trigger operation, the first virtual element to be transformed.

Operation 330: Display, in response to a second trigger operation on the editing control, a second transformation animation of the first virtual element in real time in tandem with the second trigger operation. In other words, the computer device renders the second transformation animation while the second trigger operation is being performed and before being ended.

The second transformation animation includes an animation effect that the first virtual element is transformed continuously corresponding to the second trigger operation.

In other words, corresponding dynamic transformation is performed on the first virtual element based on the second trigger operation performed by the user. Different from the preset transformation amplitude in the first transformation animation, the dynamic transformation amplitude in the second transformation animation is related to the second trigger operation performed by the user. For example, in the second transformation animation, a transformation amplitude is calculated and adjusted in real time based on an operation parameter of the second trigger operation performed by the user.

In one embodiment, the dynamic transformation amplitude includes at least one of a dynamic rotation angle, a dynamic zoom ratio, a dynamic movement distance, dynamic transparency, and a dynamic level relationship. This is not limited in the embodiments of this application.

In one embodiment, the second trigger operation includes at least one of a tap operation (for example, a one-tap operation or a double-tap operation), a long-press operation, a slide operation, a multi-point touch operation (that is, a touch operation implemented by using a plurality of fingers), a device shaking operation (that is, an operation triggered by shaking the computer device), and the like. This is not limited in the embodiments of this application. The first trigger operation is different from the second trigger operation. In one embodiment, a case of displaying the second transformation animation includes at least one of the following cases:
1. After a long-press operation on the editing control is detected, in response to a slide operation joining the long-press operation, display the second transformation animation in real time in tandem with the slide operation.

The second transformation animation includes an animation effect that the first virtual element is transformed continuously corresponding to the slide operation. In one embodiment, the dynamic transformation amplitude is a transformation amplitude determined based on a slide parameter corresponding to the slide operation. The slide parameter includes at least one of a sliding distance, a sliding speed, a sliding direction, and a sliding force. The sliding force is a pressing force corresponding to the slide operation.

For example, the dynamic transformation amplitude is in a positive correlation with the sliding distance, that is, a longer sliding distance indicates a larger dynamic transformation amplitude; the dynamic transformation amplitude is in a positive correlation with the sliding speed, that is, a faster sliding speed indicates a larger dynamic transformation amplitude; and the dynamic transformation amplitude is in a positive correlation with the sliding force, that is, a larger sliding force indicates a larger dynamic transformation amplitude.

In the foregoing embodiment, the second trigger operation is implemented by using the long-press operation and the slide operation joining the long-press operation, to precisely adjust the transformation amplitude of the first virtual element. In addition, the user does not need to tap on or switch an interface a plurality of times, but only needs to use a combination operation of a long-press and a slide, so that the transformation amplitude can be adjusted, thereby simplifying an adjustment process, and improving operation efficiency.

In one embodiment, amplitude indication information is displayed in response to the long-press operation, the amplitude indication information indicating a transformation amplitude corresponding to the first virtual element; and the second transformation animation and an information change animation are displayed in response to the slide operation joining the long-press operation, the information change animation including an animation effect that the amplitude indication information is updated based on the dynamic transformation amplitude corresponding to the slide operation.

For example, the amplitude indication information includes an amplitude indication element, and the amplitude indication element indicates the transformation amplitude corresponding to the first virtual element; and the second transformation animation and an element change animation are displayed in response to the slide operation joining the long-press operation, the element change animation including an animation effect that the amplitude indication element is updated based on the dynamic transformation amplitude corresponding to the slide operation.

For example, the amplitude indication information may be implemented as at least one of the following display information:

### (1) Progress Bar Indication Information.

For example, the progress bar indication information includes a progress bar element, and a length of the progress bar element or a position of a slide element on the progress bar element indicates the transformation amplitude corresponding to the first virtual element. As the slide operation is performed, the length of the progress bar element or the position of the slide element on the progress bar element is dynamically changed, to indicate a current transformation amplitude of the first virtual element in real time.

### (2) Dynamic Text Indication Information.

For example, the dynamic text indication information includes values. The values may be transparency, an angle, and the like. The values indicate the transformation amplitude corresponding to the first virtual element. As the slide operation is performed, the values are updated in real time, to inform the user of a current transformation amplitude, to indicate the current transformation amplitude of the first virtual element in real time.

### (3) Icon Change Indication Information

For example, the icon change indication information includes an icon, and an attribute like a size, a color, or a shape of the icon indicates the transformation amplitude corresponding to the first virtual element. For example, as the slide operation is performed, the size of the icon may be gradually increased or reduced, to reflect a change of the transformation amplitude.

### (4) Color Indication Information.

For example, different transformation amplitudes are indicated by using different colors or shades of a color.

### (5) Scale Indication Information.

For example, the scale indication information includes a scale bar and a scale indication element. The scale bar marks equal scales on a straight line to indicate a change range of a specific scalar (for example, an angle). As the slide operation is performed, a position of the scale indication element on the scale bar is dynamically changed, to indicate a current transformation amplitude of the first virtual element in real time.

The foregoing examples of the amplitude indication information are only for exemplary description, and are not limited in the embodiments of this application.

In the foregoing embodiment, in a case of precise transformation, the amplitude indication information is displayed after the long-press operation, and a current dynamic transformation amplitude is indicated in real time by using the amplitude indication information. Real-time updating of the amplitude indication information can make the user more precisely control an amplitude of an operation. The user may perform fine adjustment on the operation based on a change of the amplitude indication information until an expected transformation amplitude is reached. In addition, because the amplitude indication information provides instant feedback, the user can determine a progress and an amplitude of the operation more accurately, to reduce a misoperation caused by an inappropriate operation or misunderstanding.
2. Display a second setting area in response to a long-press operation on the editing control, the second setting area including an amplitude adjustment control; and move the amplitude adjustment control in the second setting area in response to a movement operation on the amplitude adjustment control, to display the second transformation animation.

The amplitude adjustment control is configured to adjust the transformation amplitude of the first virtual element. The movement operation is configured for moving the amplitude adjustment control in the second setting area. The dynamic transformation amplitude corresponding to the second transformation animation is determined based on a position of the amplitude adjustment control in the second setting area.

For example, the second setting area may be a progress bar. There may be scales on the progress bar, and each scale corresponds to a particular amplitude value. Alternatively, a color of the progress bar may gradually change as an amplitude increases, for example, from light to dark. The amplitude adjustment control is presented by using a slide element on the progress bar. The user may change the transformation amplitude of the first virtual element by dragging the slide element. The slide element includes at least one of a movable small dot, square, customized icon, or the like. This is not limited in the embodiments of this application. The user may long-press the slide element, and then drag the slide element to any position on the progress bar to set a required transformation amplitude. A position of the slide element corresponds to a current transformation amplitude. When the slide element is moved to a specific position, the first virtual element is transformed by a transformation amplitude corresponding to the position, so that the second transformation animation is displayed.

Alternatively, the second setting area may be implemented as a circular dial, and the amplitude adjustment control may be implemented as a pointer element on the circular dial. The user may adjust the transformation amplitude by rotating the pointer element, and the circular dial includes scales to mark different transformation amplitudes.

In the foregoing embodiment, after triggering the long-press operation, the user invokes the second setting area. The user may move the amplitude adjustment control in the second setting area, to transform the first virtual element based on a real-time position of the amplitude adjustment control. The second setting area is invoked to provide a dedicated interface for the user to perform an amplitude adjustment operation, so that an element adjustment process is more flexible and intuitive.

The foregoing uses only the long-press operation as an example for description. The operation of triggering displaying of the second setting area may further have another type, for example, a one-tap operation or a double-tap operation. The triggering displaying of the second setting area is different from the first trigger operation. This is not limited in the embodiments of this application.
3. After a long-press operation on the editing control is detected, display the second transformation animation in response to a first tap operation on a first position in the virtual scene and a second tap operation on a second position in the virtual scene.

The dynamic transformation amplitude corresponding to the second transformation animation is determined based on a distance between the first position and the second position. For example, the dynamic rotation angle, the dynamic transparency, or the like is determined based on a horizontal coordinate change amount between the first position and the second position.

In the foregoing embodiment, the dynamic transformation amplitude in the second transformation animation is determined based on the distance between the first position and the second position, so that the user can flexibly control a scale and a range of transformation based on an actual requirement. In addition, by using a combination operation of a long-press and a tap, the user can quickly trigger a transformation animation without complex operations or waiting time, so that operation efficiency is improved, and the user can complete an editing task more quickly.
4. Display an amplitude entry box in response to a long-press operation on the editing control, and display, in response to an entry operation on the amplitude entry box, the second transformation animation based on an entered transformation amplitude.

For example, after the long-press operation on the editing control is detected, the amplitude entry box is displayed. The amplitude entry box allows the user to directly enter an expected transformation amplitude. When the user performs the entry operation on the amplitude entry box, the computer device displays the second transformation animation in real time based on the entered transformation amplitude.

The foregoing examples of displaying the second transformation animation are only for exemplary description, and are not limited in the embodiments of this application.

In some embodiments, if both the first trigger operation and the second trigger operation are implemented as tap-and-press operations (for example, operations such as a tap and a long-press), the computer device may detect duration of the tap-and-press operation initiated by the user, to determine whether a currently triggered tap-and-press operation is the first trigger operation or the second trigger operation. The tap-and-press operation is an operation of tapping on and pressing an editing control area.

In one embodiment, when operation duration of a tap-and-press operation is shorter than or equal to a duration threshold, the tap-and-press operation is the first trigger operation. After a first tap-and-press operation on the editing control is detected, the first transformation animation of the first virtual element is displayed in response to that the first tap-and-press operation is ended and operation duration of the first tap-and-press operation is less than or equal to the duration threshold. The operation duration of the first tap-and-press operation is duration from a start moment to an end moment of the first tap-and-press operation.

In other words, after the first tap-and-press operation on the editing control is detected, in response to that the first tap-and-press operation is ended and the operation duration of the first tap-and-press operation is less than or equal to the duration threshold, the first tap-and-press operation is used as the first trigger operation, and the first transformation animation of the first virtual element is displayed.

For example, an example in which the first trigger operation is implemented as a tap operation and the second trigger operation is implemented as a combination of a long-press operation and a slide operation is used for description.

In one embodiment, the duration threshold may be a preset threshold. For example, if the duration threshold is set to 0.3 s, when duration for which the user taps on and presses the editing control (that is, the operation duration of the first tap-and-press operation) is less than or equal to 0.3 s, the user performs the first trigger operation. In this case, the first transformation animation is displayed. The tap-and-press duration is time elapsed from when the user starts tapping and pressing to when the user ends tapping and pressing.

In one embodiment, when operation duration of a tap-and-press operation is longer than the duration threshold, the tap-and-press operation is the second trigger operation. After a second tap-and-press operation on the editing control is detected, the second transformation animation of the first virtual element is displayed in real time in tandem with the second tap-and-press operation in response to that operation duration of the second tap-and-press operation is longer than the duration threshold. Before the second tap-and-press operation is ended, the operation duration of the second tap-and-press operation is duration from a start moment of the tap-and-press operation to a current moment, and the current moment is a moment at which the second tap-and-press operation is currently being performed on the editing control. After the second tap-and-press operation is ended, the operation duration of the second tap-and-press operation is duration from the start moment to an end moment of the second tap-and-press operation.

In other words, after the second tap-and-press operation on the editing control is detected, in response to that the operation duration of the second tap-and-press operation is longer than the duration threshold, the second tap-and-press operation is used as the second trigger operation, and the second transformation animation of the first virtual element is displayed in real time in tandem with the second trigger operation.

For example, if duration for which the user taps on and presses the editing control (that is, the operation duration of the second tap-and-press operation) is longer than 0.3 s, the user performs the second trigger operation. When the user does not end tapping, the tap-and-press duration is duration from a moment at which the user starts tapping and pressing to a current moment, is a dynamically changed value, and is continuously increased as the user keeps pressing.

In the foregoing embodiment, whether a tap-and-press operation on the editing control is the first trigger operation or the second trigger operation is determined based on operation duration of the tap-and-press operation, to improve accuracy and convenience of performing an editing operation by the user.

In some embodiments, a first account is logged in to the computer device, and the duration threshold may be dynamically updated by using historical operation data generated by the first account.

In one embodiment, operation duration of a plurality of target tap-and-press operations generated by the first account in a historical time period is obtained, the plurality of target tap-and-press operations being historical tap-and-press operations being the first trigger operation, and operation duration of the target tap-and-press operation being duration from a start moment to an end moment of the target tap-and-press operation; and the duration threshold is updated based on the operation duration of the plurality of target tap-and-press operations.

In one embodiment, shortest duration in the operation duration of the plurality of target tap-and-press operations is used as the duration threshold; or an average value of the operation duration of the plurality of target tap-and-press operations is used as the duration threshold; or a median of the operation duration of the plurality of target tap-and-press operations is used as the duration threshold. This is not limited in the embodiments of this application.

For example, the average value is used as an example for description. Assuming that in the historical time, the user triggers the first trigger operation four times, and operation duration of the first trigger operation is respectively 0.1 s, 0.2 s, 0.1 s, and 0.2 s, 0.15 may be used as latest duration threshold. The duration threshold is dynamically adjusted, so that the duration threshold better conforms to expectations and operation habits of the user.

In the foregoing embodiment, when a tap-and-press operation is performed on the editing control, a representation form of the editing control may be further changed, to prompt the user whether the first trigger operation or the second trigger operation is currently performed on the editing control. For example, it is assumed that the duration threshold is 0.3 s, and the user taps on and presses the editing control. From 0 s to 0.3 s, the editing control is displayed in red, to indicate that the first trigger operation is currently triggered. After 0.3 s, the editing control is displayed in green, to indicate that the second trigger operation is currently triggered.

In conclusion, a user may perform customized editing on a virtual element in a virtual scene by triggering an editing control. When a first trigger operation is performed on the editing control, the virtual element is transformed by a preset transformation amplitude, and the user does not need to manually set or adjust a transformation amplitude, to implement rapid transformation control on the virtual element. When a second trigger operation is performed on the editing control, the virtual element is transformed following the second trigger operation by a dynamic transformation amplitude corresponding to the second trigger operation. Therefore, the second trigger operation is controlled, so that the transformation amplitude of the virtual element can be precisely controlled, to implement precise transformation control on the virtual element. Therefore, rapid transformation control and precise transformation control on the virtual element are integrated on one editing control, so that the user can complete a plurality of types of transformation control on the virtual element on one editing control. This improves flexibility of performing transformation control on the virtual element, and simplifies operations for implementing the plurality of types of transformation control, thereby improving operation efficiency of the user for controlling the virtual element to be transformed, and reducing waste of computer operation resources.

The following describes a procedure of the virtual element display method provided in this application by using an example in which the editing control is implemented as a rotation control.

The embodiment in FIG. 3 may alternatively be implemented as a method shown in FIG. 4. FIG. 4 is a flowchart of a virtual element display method according to an exemplary embodiment of this application. An example in which the method is applied to a computer device is used for description. The computer device may be the terminal 110 shown in FIG. 1. The method includes operation 410 to operation 430.

Operation 410: Display a first virtual element in a virtual scene, and display a rotation control.

The rotation control is configured to control the first virtual element to rotate in the virtual scene.

In one embodiment, there may be one or more rotation controls. When there are a plurality of rotation controls, the plurality of rotation controls respectively control different rotation directions.

For example, when there is one rotation control, the rotation control may control the first virtual element to be rotated clockwise or counterclockwise. When the rotation control includes a first rotation control and a second rotation control, the first rotation control and the second rotation control respectively control the first virtual element to be rotated in different directions. The first rotation control may control the first virtual element to be rotated clockwise or counterclockwise, and the second rotation control may control the first virtual element to be rotated counterclockwise or clockwise.

Operation 420: Display a first rotation animation of the first virtual element in response to a first trigger operation on the rotation control. In other words, the computer device renders the first rotation animation in response to the first trigger operation.

The first rotation animation includes an animation effect that the first virtual element is rotated by a preset rotation angle.

In one embodiment, the first rotation animation includes an animation effect that the first virtual element is rotated by the preset rotation angle in a first rotation direction.

In some embodiments, the preset rotation angle is a system-default rotation angle.

In some embodiments, the preset rotation angle is a rotation angle pre-configured by a user. In one embodiment, a first setting area is displayed, the first setting area being configured for configuring the preset rotation angle corresponding to the first trigger operation; and the preset rotation angle is configured for the first trigger operation in response to an angle configuration operation on the first trigger operation in the first setting area. The angle configuration operation is configured for configuring the preset rotation angle for the first trigger operation.

For example, before the first trigger operation is detected, the first setting area of the first virtual element is displayed on a scene editing interface. The first setting area is configured for configuring the preset rotation angle of the first virtual element when the first trigger operation is triggered. In one embodiment, an angle entry box or an angle list is displayed in the first setting area, and the preset rotation angle is entered in the angle entry box or the preset rotation angle is selected from the angle list, so that configuration of the preset rotation angle corresponding to the first trigger operation is completed.

In one embodiment, the first rotation animation includes the animation effect that the first virtual element is rotated by the preset rotation angle in the first rotation direction.

In some embodiments, if there is one rotation control, when the first trigger operation on the rotation control is performed, the first rotation direction of the first virtual element further needs to be determined. In one embodiment, a case of determining the first rotation direction of the first virtual element includes at least one of the following cases:
Case 1: The first rotation direction of the first virtual element is a preset rotation direction.

In some embodiments, the first rotation direction is a system-default direction.

In some embodiments, the first rotation direction is a direction pre-configured by the user. In one embodiment, the first setting area is further configured for configuring the first rotation direction corresponding to the first trigger operation; and the first rotation direction is configured for the first trigger operation in response to a direction configuration operation on the first trigger operation in the first setting area. The direction configuration operation is configured for configuring the first rotation direction for the first trigger operation.

For example, a direction entry box or a direction list is displayed in the first setting area, and the first rotation direction is entered in the direction entry box or the first rotation direction is selected from the direction list, so that configuration of the first rotation direction corresponding to the first trigger operation is completed.

In the foregoing embodiment, the computer device may directly respond to a preset rotation action, to simplify an operation process, and improve an operation response speed.
Case 2: The first rotation direction of the first virtual element is determined based on the first trigger operation.

In one embodiment, the first rotation direction is a rotation direction determined based on a trigger position of the first trigger operation on the rotation control. For example, the rotation control is divided into a left area and a right area. When the trigger position of the first trigger operation on the rotation control is in the left area, the first rotation direction corresponding to the first virtual element is clockwise rotation. When the trigger position of the first trigger operation on the rotation control is in the right area, the first rotation direction corresponding to the first virtual element is counterclockwise rotation.

In the foregoing embodiment, a rotation direction is determined based on a trigger position, so that a trigger operation is more flexible, and the user may trigger different rotation effects at different positions of the rotation control based on requirements of the user.

In some embodiments, if there are a plurality of rotation controls, a rotation direction corresponding to the rotation control triggered by the first trigger operation is used as the first rotation direction of the first virtual element.

For example, when the rotation control includes the first rotation control and the second rotation control, the first rotation control may control the first virtual element to be rotated clockwise, and the second rotation control may control the first virtual element to be rotated counterclockwise. If the first trigger operation on the first rotation control is detected, the first rotation direction of the first virtual element is clockwise rotation. If the first trigger operation on the second rotation control is detected, the first rotation direction of the first virtual element is counterclockwise rotation.

In one embodiment, the first trigger operation includes at least one of a tap operation (for example, a one-tap operation or a double-tap operation), a long-press operation, a slide operation, and the like. This is not limited in the embodiments of this application.

An example in which the first trigger operation is implemented as a tap operation is used for description. In one embodiment, the first rotation animation of the first virtual element is displayed in response to a tap operation on the rotation control.

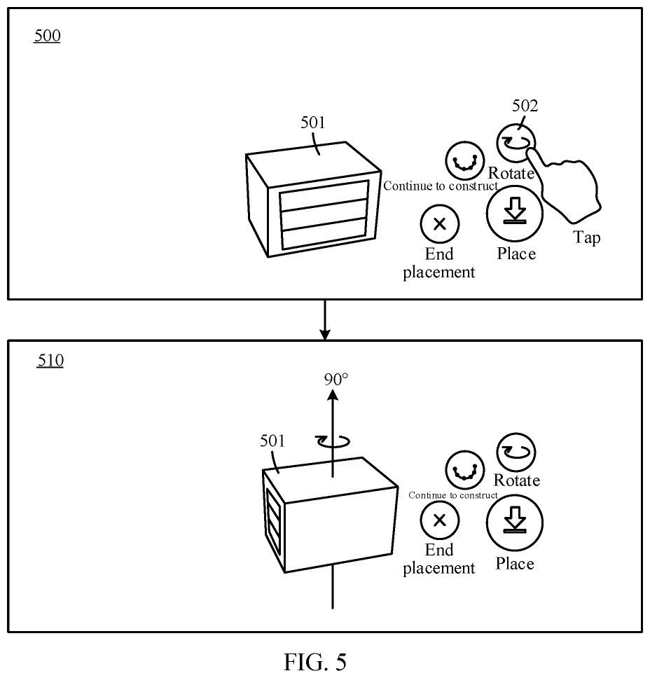

For example, FIG. 5 is a schematic diagram of a first trigger operation. As shown in FIG. 5, an article 501 in a virtual scene and a rotation control 502 are displayed on an interface 500. After the user taps on the rotation control 502, as shown on an interface 510, the article 501 is rotated by 90° clockwise.

In some embodiments, the first virtual element corresponds to a plurality of rotation axes. When the first virtual element is rotated, a rotation axis further needs to be determined. For example, the first virtual element includes a three-dimensional virtual element in a three-dimensional virtual scene, and a plurality of rotation axes corresponding to the three-dimensional virtual element includes an X axis, a Y axis, and a Z axis. In one embodiment, a case of determining a first rotation axis of the first virtual element includes at least one of the following cases:
1. Select the first rotation axis as the rotation axis of the first virtual element before the first trigger operation is triggered.

In one embodiment, a rotation axis selection area is displayed; and when a selection operation on the first rotation axis in the rotation axis selection area is detected, the first rotation animation of the first virtual element is displayed in response to the first trigger operation on the rotation control. The first rotation animation includes an animation effect that the first virtual element is rotated around the first rotation axis.

The rotation axis selection area includes a plurality of rotation axes. In one embodiment, the plurality of rotation axes include the X axis, the Y axis, the Z axis, and the like. For example, the rotation axis selection area may be implemented in a list form, an icon form, a control form, or the like. This is not limited in the embodiments of this application.

For the list form, the rotation axis selection area may be implemented as a list of rotation axes, for example, the X axis, the Y axis, and the Z axis. The user may select one of the three rotation axes as the rotation axis of the first virtual element, that is, the first rotation axis.

For the icon form, the rotation axis rotation area may be implemented as a three-dimensional coordinate axis icon. The three-dimensional coordinate axis icon includes the X axis, the Y axis, or the Z axis. The three-dimensional coordinate axis icon is rotated, to change a current rotation axis of the first virtual element.

For the control form, the rotation axis rotation area may be implemented as three trigger buttons, and the three trigger buttons respectively indicate the X axis, the Y axis, and the Z axis. The user taps on the trigger button indicating the X axis, and the trigger button may be highlighted. In this case, it indicates that the X axis is selected as the rotation axis of the first virtual element.
2. Determine the first rotation axis corresponding to the first virtual element based on a trigger stage at which the first trigger operation is ended.

In one embodiment, the first trigger operation includes a plurality of trigger stages, and the plurality of trigger stages respectively correspond to different rotation axes. After the first trigger operation on the rotation control is detected, in response to that the first trigger operation is ended, the first rotation animation is displayed based on the trigger stage at which the first trigger operation is ended, the trigger stage at which the first trigger operation is ended corresponding to the first rotation axis, and the first rotation animation including the animation effect that the first virtual element is rotated around the first rotation axis.

The plurality of trigger stages of the first trigger operation include a first trigger stage, a second trigger stage, and a third trigger stage. A rotation axis corresponding to the first trigger stage is the X axis, a rotation axis corresponding to the second trigger stage is the Y axis, and a rotation axis corresponding to the third trigger stage is the Z axis.

An example in which the first trigger operation is implemented as a tap operation is used for description. In one embodiment, the tap operation may be a continuous one-tap operation, for example, three continuous one-tap operations. A first one-tap indicates the first trigger stage, a second one-tap indicates the second trigger stage, and a third one-tap indicates the third trigger stage. After the first one-tap is ended, if the second one-tap is not triggered in preset duration, it indicates that the first trigger operation is ended, that is, an operation stage at which the first trigger operation is ended is the first trigger stage. In this case, it is determined that the first rotation axis is the X axis. After the second one-tap is ended, if the third one-tap is not triggered in preset duration, it indicates that the first trigger operation is ended, that is, the operation stage at which the first trigger operation is ended is the second trigger stage. In this case, it is determined that the first rotation axis is the Y axis. After the third one-tap is ended, the first trigger operation is ended, that is, the operation stage at which the first trigger operation is ended is the third trigger stage. In this case, it is determined that the first rotation axis is the Z axis.

An example in which the first trigger operation is implemented as a long-press operation is used for description. In one embodiment, operation duration of the long-press operation is divided into a first operation time (corresponding to the first trigger stage), a second operation time (corresponding to the second trigger stage), and a third operation period (corresponding to the third trigger stage). For example, it is assumed that the operation duration is 3 s, and the rotation control is long-pressed. If the long-press operation is ended when long-press duration is in an interval (0 s, 1 s], it indicates that an operation stage at which the first trigger operation is ended is the first trigger stage. In this case, it is determined that the first rotation axis is the X axis. If the long-press operation is ended when the long-press duration is in an interval (1 s, 2 s], it indicates that the operation stage at which the first trigger operation is ended is the second trigger stage. In this case, it is determined that the first rotation axis is the Y axis. If the long-press operation is ended when the long-press duration is in an interval (2 s, 3 s], it indicates that the operation stage at which the first trigger operation is ended is the third trigger stage. In this case, it is determined that the first rotation axis is the Z axis.

In one embodiment, if the long-press operation is still not ended after the long-press operation reaches the third trigger stage, the foregoing determining process is looped. To be specific, if the long-press operation is ended when the long-press duration is in an interval (3 s, 4 s], it indicates that the operation stage at which the first trigger operation is ended is the first trigger stage. In this case, it is determined that the first rotation axis is the X axis. Details are not described herein again.

The foregoing examples of the trigger operation and the trigger stage are only for exemplary description, and are not limited in the embodiments of this application.

In one embodiment, representation forms of the rotation control may be different at different trigger stages. The representation forms include a fill color, transparency, a shape, fill texture, a size, fill text, and the like, and are not limited in the embodiments of this application.

An example in which the representation form is implemented as a color is used for description. When the first trigger operation is at the first trigger stage, a fill color of the rotation control is red. When the first trigger operation is at the second trigger stage, the fill color of the rotation control is blue. When the first trigger operation is at the third trigger stage, the fill color of the rotation control is green.

In some embodiments, the rotation control may be implemented in a form of a progress bar.

For example, it is assumed that the operation duration is 3 s, the rotation control is long-pressed, and the rotation control in the form of the progress bar changes a progress value based on long-press duration. If the long-press duration is in an interval (0 s, 1 s], a first progress value increasing animation is displayed (for example, first one third of an area of a white progress bar is gradually filled with red). If the long-press operation is ended in this period, the operation stage of the first trigger operation is the first trigger stage, and it is determined that the first rotation axis is the X axis. If the long-press duration is in an interval (1 s, 2 s], a second progress value increasing animation is displayed (for example, middle one third of the area of the white progress bar is gradually filled with blue). If the long-press operation is ended in this period, the operation stage of the first trigger operation is the second trigger stage, and it is determined that the first rotation axis is the Y axis. If the long-press duration is in an interval (2 s, 3 s], a third progress value increasing animation is displayed (for example, last one third of the area of the white progress bar is gradually filled with green). If the long-press operation is ended in this period, the operation stage of the first trigger operation is the third trigger stage, and it is determined that the first rotation axis is the Z axis.

In one embodiment, preset rotation angles corresponding to different rotation axes may be the same or may be different. For example, the preset rotation angles corresponding to different rotation axes are the same, that is, even though a currently triggered rotation axis is the X axis, the Y axis, or the Z axis, rotation angles triggered a single time are all the preset rotation angle. Alternatively, the preset rotation angles corresponding to different rotation axes are different. For example, a preset rotation angle corresponding to the X axis is 45°, a preset rotation angle corresponding to the Y axis is 90°, and a preset rotation angle corresponding to the Z axis is 15°.

In the foregoing embodiment, the rotation axis of the first virtual element when the rotation operation is performed is determined based on the trigger stage at which the first trigger operation is ended. The rotation axis is determined when the first trigger operation is performed, so that operations of determining the rotation axis based on another operation are omitted, and efficiency of performing the rotation operation is improved. In addition, the user can determine the rotation axis when performing the first trigger operation, to determine the rotation axis more precisely. This helps ensure that the virtual element is rotated according to expectation of the user, and reduces a possibility of a misoperation.

Operation 430: Display, in response to a second trigger operation on the rotation control, a second rotation animation of the first virtual element in real time in tandem with the second trigger operation. In other words, the computer device renders the second rotation animation while the second trigger operation is being performed and before being ended.

The second rotation animation includes an animation effect that the first virtual element is rotated by a dynamic rotation angle corresponding to the second trigger operation. The first trigger operation is different from the second trigger operation.

In one embodiment, the second rotation animation includes an animation effect that the first virtual element is rotated by the dynamic rotation angle corresponding to the second trigger operation in a second rotation direction.

In some embodiments, if there is one rotation control, when the second trigger operation on the rotation control is performed, the second rotation direction of the first virtual element further needs to be determined. In one embodiment, a case of determining the second rotation direction of the first virtual element includes at least one of the following cases:
Case 1: The second rotation direction of the first virtual element is a preset rotation direction.

In some embodiments, the second rotation direction is a system-default direction.

In some other embodiments, the second rotation direction is a direction pre-configured by the user. In one embodiment, a third setting area is displayed, the third setting area being configured for configuring the second rotation direction corresponding to the second trigger operation; and the second rotation direction is configured for the second trigger operation in response to a direction configuration operation on the second trigger operation in the third setting area. The direction configuration operation is configured for configuring the second rotation direction for the second trigger operation.

For example, before the second trigger operation is detected, the third setting area of the first virtual element is displayed on a scene editing interface. The third setting area is configured for configuring the second rotation direction of the first virtual element when the second trigger operation is triggered. A direction entry box or a direction list is displayed in the third setting area, and the second rotation direction is entered in the direction entry box or the second rotation direction is selected from the direction list, so that configuration of the second rotation direction corresponding to the second trigger operation is completed.
Case 2: The second rotation direction of the first virtual element is determined based on the second trigger operation.

In one embodiment, the second rotation direction is a rotation direction determined based on a trigger position of the second trigger operation on the rotation control. For example, the rotation control is divided into a left area and a right area. When the trigger position of the second trigger operation on the rotation control is in the left area, the second rotation direction corresponding to the first virtual element is clockwise rotation. When the trigger position of the first trigger operation on the rotation control is in the right area, the second rotation direction corresponding to the first virtual element is counterclockwise rotation.

In some embodiments, the second trigger operation is implemented as a long-press operation and a slide operation. After a long-press operation on the rotation control is detected, in response to a slide operation joining the long-press operation, the second rotation animation is displayed in real time in tandem with the slide operation.

In one embodiment, the second rotation direction of the first virtual element is determined based on a sliding direction of the slide operation. For example, when the sliding direction of the slide operation is in a first angle range, the second rotation direction of the first virtual element is clockwise rotation. When the sliding direction of the slide operation is in a second angle range, the second rotation direction of the first virtual element is counterclockwise rotation.

For example, assuming that the slide operation is an operation effective in directions of 360°, the first angle range may be set to (180°, 360°], and the second angle range may be set to [0°, 180°). The first angle range (180°, 360°] may be implemented as angles at the left side of the computer device. In other words, when the sliding direction of the slide operation is the left, the second rotation direction of the first virtual element is clockwise rotation. The second angle range [0°, 180°) may be implemented as angles at the right side of the computer device. In other words, when the sliding direction of the slide operation is the right, the second rotation direction of the first virtual element is counterclockwise rotation.

In some embodiments, if there are a plurality of rotation controls, a rotation direction corresponding to the rotation control triggered by the second trigger operation is used as the second rotation direction of the first virtual element.

For example, when the rotation control includes the first rotation control and the second rotation control, the first rotation control may control the first virtual element to be rotated clockwise, and the second rotation control may control the first virtual element to be rotated counterclockwise. If the second trigger operation on the first rotation control is detected, the second rotation direction of the first virtual element is clockwise rotation. If the second trigger operation on the second rotation control is detected, the second rotation direction of the first virtual element is counterclockwise rotation.

In one embodiment, the second trigger operation includes at least one of a tap operation (for example, a one-tap operation or a double-tap operation), a long-press operation, a slide operation, and the like. This is not limited in the embodiments of this application.

In some embodiments, after a long-press operation on the rotation control is detected, in response to a slide operation joining the long-press operation, the second rotation animation is displayed in real time following the slide operation. The second rotation animation includes an animation effect that the first virtual element is rotated by a dynamic rotation angle corresponding to the slide operation in the second rotation direction.

In one embodiment, an angle identifier is displayed in response to the long-press operation, the angle identifier indicating a current rotation angle of the first virtual element in the virtual scene; and the second rotation animation and an identifier change animation are displayed in response to the slide operation jointing the long-press operation, the identifier change animation including an animation effect that the angle identifier is updated based on the dynamic rotation angle corresponding to the slide operation.

In one embodiment, the angle identifier may be implemented as a scale display area. For example, the scale display area is displayed in response to the long-press operation. The scale display area includes a scale bar and a scale indication element. A position of the scale indication element on the scale bar indicates the current rotation angle of the first virtual element in the virtual scene.

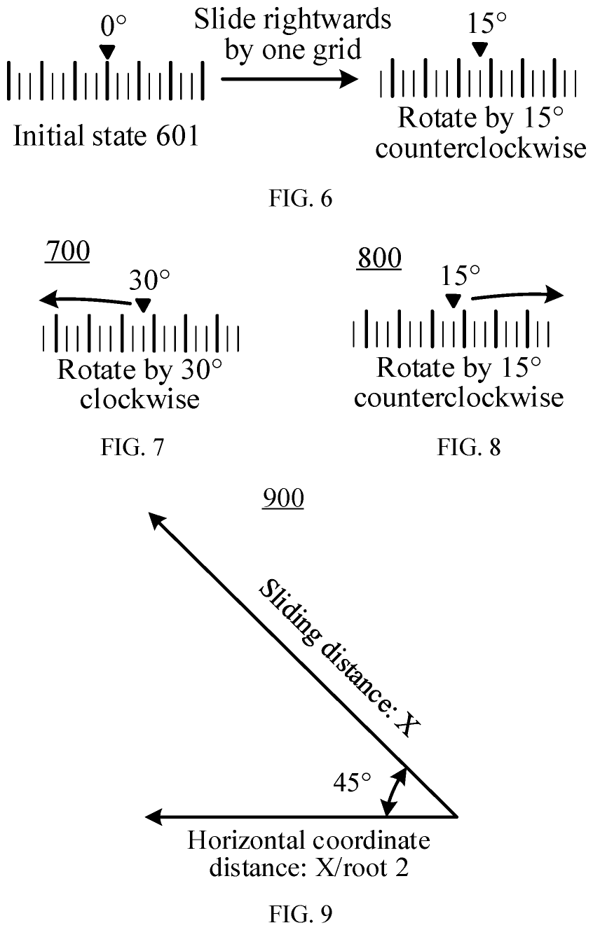

For example, FIG. 6 is a schematic diagram of a scale display area. As shown in FIG. 6, a rotation angle corresponding to each grid of scale in a scale bar is 15°. An example of the rotation angle corresponding to each grid of scale herein is only for exemplary description, and is not limited in the embodiments of this application. For example, the rotation angle corresponding to each grid of scale may alternatively be 1°, 5°, 30°, or the like.

In an initial state 601, a scale indication element (an inverted triangle identifier in FIG. 6) indicates that an initial rotation angle of the first virtual element is 0°. The scale indication element may further include text “0°”, to clearly indicate the current rotation angle of the first virtual element.

If the rotation control is long-pressed and then slid rightwards, a relative position between the scale bar and the scale indication element is changed. For example, the rotation control is long-pressed and then slid rightwards so that the scale bar moves rightwards by one grid, to indicate that the first virtual element is rotated by 15° counterclockwise.

In response to the slide operation, the scale indication element is fixed, and a movement animation of the scale bar is displayed. Alternatively, in response to the slide operation, the scale bar is fixed, and the movement animation of the scale indication element is displayed. For example, the movement of the scale bar is used as an example for description.

Referring to FIG. 7, a schematic diagram 700 indicates that the rotation control is long-pressed and then slid leftwards so that the scale bar moves leftwards by two grids, to indicate that the first virtual element is rotated by 30° clockwise. Referring to FIG. 8, a schematic diagram 800 indicates that the rotation control is long-pressed and then slid rightwards so that the scale bar moves rightwards by one grid, to indicate that the first virtual element is rotated by 15° counterclockwise.

In one embodiment, the dynamic rotation angle is a rotation angle determined based on a slide parameter corresponding to the slide operation. The slide parameter includes at least one of a sliding distance, a sliding speed, a sliding direction, and a sliding force. An example in which the dynamic rotation angle is a rotation angle determined based on the sliding distance and the sliding direction corresponding to the slide operation is used for description.

For example, when sliding is performed in a left-right horizontal direction, a rotation angle is directly determined based on a sliding distance. When an article is moved leftwards, each time a horizontal coordinate moves by 1 px, the article is rotated by 1° clockwise in the horizontal direction. When the article is moved rightwards, each time the horizontal coordinate moves by 1 px, the article is rotated by 1° counterclockwise in the horizontal direction.

When sliding is performed in a left-right non-horizontal direction, a horizontal coordinate distance is calculated based on a sliding distance, and a rotation angle is determined based on the horizontal coordinate distance. For example, FIG. 9 is a schematic diagram of a horizontal coordinate distance. As shown in FIG. 9, in a schematic diagram 900, when sliding by an X distance is performed in a 45° direction of the top left of a screen, it may be calculated that the horizontal coordinate distance is X/root 2. If a movement distance is X (namely, a sliding distance) being root 2 (in px), the horizontal coordinate distance is 1 px. In this case, an article is rotated by 1° clockwise in a horizontal direction.

A correspondence between a horizontal coordinate movement amount and an angle, that is, the correspondence that 1 px corresponds to 1°, is not limited in the embodiments of this application. For example, 1 px may alternatively correspond to 5°. In other words, when the article is moved leftwards, each time the horizontal coordinate moves by 1 px, the article is rotated by 5° clockwise in the horizontal direction. When the article is moved rightwards, each time the horizontal coordinate moves by 1 px, the article is rotated by 5° counterclockwise in the horizontal direction.

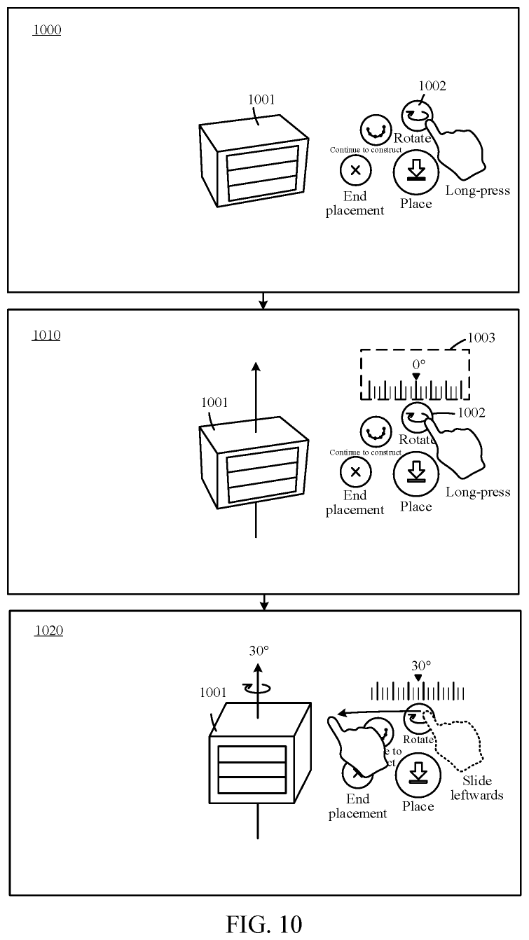

For example, FIG. 10 is a schematic diagram of a second trigger operation. As shown in FIG. 10, an article 1001 in a virtual scene and a rotation control 1002 are displayed on an interface 1000. After the user long-presses the rotation control 1002, as shown on an interface 1010, a scale display area 1003 is displayed. The scale display area 1003 includes a scale bar and a scale indication element. The scale indication element is displayed at 0°, to indicate that a current rotation angle of the article 1001 is 0°. When the rotation control 1002 is long-pressed, the rotation control 1002 is slid leftwards, and the scale bar moves leftwards by two grids. As shown on an interface 1020, the article 1001 is rotated by 30° clockwise. In this case, the scale indication element in the scale display area 1003 is displayed at 30°.

In some embodiments, after a long-press operation on the rotation control is detected, the second rotation animation is displayed in response to a first tap operation on a first position in the virtual scene and a second tap operation on a second position in the virtual scene.

The dynamic rotation angle is an angle determined based on a distance between the first position and the second position. For example, assuming that the distance between the first position and the second position is 10 px, the rotation angle of the first virtual element is 10°.

In the foregoing embodiment, a rotation direction of the first virtual element may be further determined based on the first position and the second position. If the first position is on the left side of the second position, the rotation direction of the first virtual element is counterclockwise rotation. If the first position is on the right side of the second position, the rotation direction of the first virtual element is clockwise rotation.

In some embodiments, the first virtual element corresponds to a plurality of rotation axes. When the first virtual element is rotated, a rotation axis further needs to be determined. For example, the first virtual element includes a three-dimensional virtual element in a three-dimensional virtual scene, and a plurality of rotation axes corresponding to the three-dimensional virtual element includes an X axis, a Y axis, and a Z axis. In one embodiment, a case of determining a second rotation axis of the first virtual element includes at least one of the following cases:
1. Select the second rotation axis as the rotation axis of the first virtual element before the second trigger operation is triggered.

In one embodiment, a rotation axis selection area is displayed; and when a selection operation on the second rotation axis in the rotation axis selection area is detected, the second rotation animation is displayed in real time in tandem with the second trigger operation in response to the second trigger operation on the rotation control. The second rotation animation includes an animation effect that the first virtual element is rotated around the second rotation axis.

The rotation axis selection area includes a plurality of rotation axes. For example, the rotation axis selection area may be implemented in a list form, an icon form, a control form, or the like. This is not limited in the embodiments of this application.
2. Determine the second rotation axis corresponding to the first virtual element based on the second trigger operation.

In one embodiment, after the long-press operation on the editing control is detected, in response to the slide operation joining the long-press operation, the second rotation animation is displayed in real time in tandem with the slide operation based on long-press duration of the long-press operation, the long-press duration of the long-press operation corresponding to the second rotation axis, and the second rotation animation including an animation effect that the first virtual element is rotated around the second rotation axis.

For example, after the long-press operation on the editing control is detected, in response to the slide operation joining the long-press operation, a representation form of the rotation control is displayed as a representation form corresponding to the long-press duration, the representation form corresponding to the long-press duration indicating the second rotation axis; and the rotation control including a plurality of representation forms, and the plurality of representation forms respectively indicating different rotation axes.

In other words, in response to the long-press operation on the rotation control, a rotation control in a target representation form is displayed based on the long-press duration of the long-press operation. The target representation form is the representation form corresponding to the long-press duration. The target representation form indicates the second rotation axis. In response to the slide operation joining the long-press operation, the second rotation animation is displayed in real time in tandem with the slide operation based on the target representation form. The second rotation animation includes the animation effect that the first virtual element is rotated around the second rotation axis.

In one embodiment, the long-press duration of the long-press operation is divided into a first operation period, a second operation period, and a third operation period. In one embodiment, representation forms of the rotation control may be different in different operation time periods. The representation forms include a fill color, transparency, a shape, fill texture, a size, fill text, and the like, and are not limited in the embodiments of this application.

An example in which the representation form is implemented as a color is used for description. When the long-press operation is in the first operation period, a fill color of the rotation control is red. When the long-press operation is in the second operation period, the fill color of the rotation control is blue. When the long-press operation is in the third operation period, the fill color of the rotation control is green.

Different representation forms correspond to different rotation axes. For example, the representation form of the rotation control includes a first representation form, a second representation form, and a third representation form. For example, it is assumed that the operation duration is 3 s, and the rotation control is long-pressed. If the long-press duration is in an interval (0 s, 1 s], a red rotation control is displayed. In this case, if the slide operation is performed, the second rotation axis of the first virtual element is the X axis. If the long-press duration is in an interval (1 s, 2 s], a blue rotation control is displayed. In this case, if the slide operation is performed, the second rotation axis of the first virtual element is the Y axis. If the long-press duration is in an interval (2 s, 3 s], a green rotation control is displayed. In this case, if the slide operation is performed, the second rotation axis of the first virtual element is the Z axis. If the long-press operation is not ended, the foregoing determining process is looped. To be specific, if the long-press duration is in an interval (3 s, 4 s], the red rotation control is displayed. In this case, if the slide operation is performed, the second rotation axis of the first virtual element is the X axis. Details are not described herein again.

The foregoing examples of the trigger operation and the trigger stage are only for exemplary description, and are not limited in the embodiments of this application.

In the foregoing embodiment, the rotation axis is determined when the second trigger operation is performed, so that operations of determining the rotation axis based on another operation are omitted, and efficiency of performing the rotation operation is improved. The user can determine the rotation axis when performing the second trigger operation, to determine the rotation axis more precisely. This helps ensure that the virtual element is rotated according to expectation of the user, and reduces a possibility of a misoperation.

In conclusion, a user may perform customized editing on a virtual element in a virtual scene by triggering an editing control. When a first trigger operation is performed on the editing control, the virtual element is transformed by a preset transformation amplitude, and the user does not need to manually set or adjust a transformation amplitude, to implement rapid transformation control on the virtual element. When a second trigger operation is performed on the editing control, the virtual element is transformed following the second trigger operation by a dynamic transformation amplitude corresponding to the second trigger operation. Therefore, the second trigger operation is controlled, so that the transformation amplitude of the virtual element can be precisely controlled, to implement precise transformation control on the virtual element. Therefore, rapid transformation control and precise transformation control on the virtual element are integrated on one editing control, so that the user can complete a plurality of types of transformation control on the virtual element on one editing control. This improves flexibility of performing transformation control on the virtual element, and simplifies operations for implementing the plurality of types of transformation control, thereby improving operation efficiency of the user for controlling the virtual element to be transformed, and reducing waste of computer operation resources.

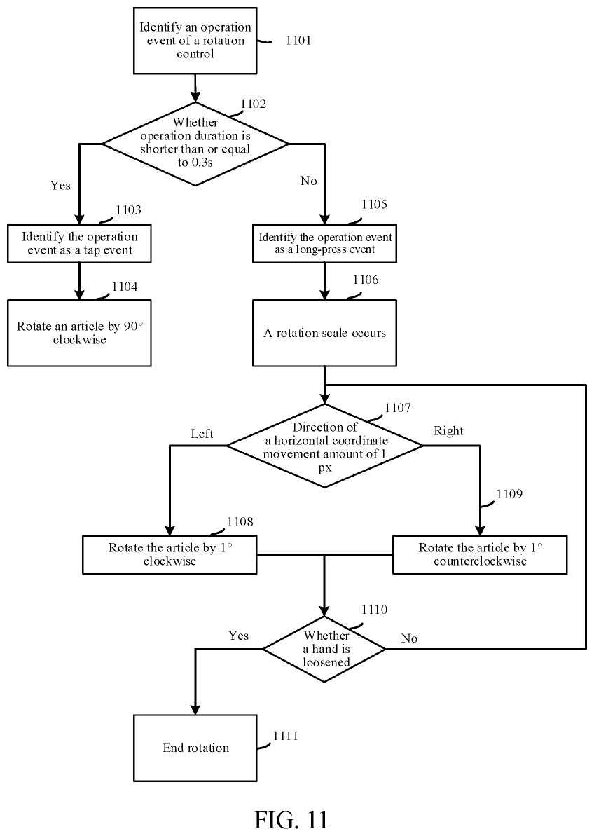

For example, FIG. 11 is an implementation flowchart of a rotation control according to an exemplary embodiment of this application.

Operation 1101: Identify an operation event of the rotation control.

For example, a scene editing interface of a game is displayed, and a virtual scene is edited on the scene editing interface, for example, an article (for example, a virtual character, a virtual vehicle, or a virtual building) is added to the virtual scene. After the article is added, an editing operation like a rotation operation, a movement operation, or a zoom operation, may be performed on the article after the article is selected. The following uses the rotation operation as an example for description.

In one embodiment, the rotation control is displayed on the scene editing interface, to implement the rotation operation. If a user operation is detected on the rotation control, the user operation is identified, to determine operation duration of the user operation.

Operation 1102: Determine whether the operation duration is shorter than or equal to 0.3 s.

For example, it is determined whether the operation duration of the user operation triggered on the rotation control is shorter than or equal to 0.3 s.

Operation 1103: Identify the operation event as a tap event if it is determined that the operation duration is shorter than or equal to 0.3 s.

For example, if the operation duration of the user operation triggered on the rotation control is shorter than or equal to 0.3 s, it indicates that the user operation is a tap operation, and the user operation is identified as a first trigger operation. The first trigger operation is configured for rotating an article by a preset rotation angle.

Operation 1104: Rotate the article by 90° clockwise.

For example, in response to the tap operation, the article is rotated by the preset rotation angle (90°) in a preset rotation direction (clockwise), that is, the article is rotated by 90° clockwise.

Operation 1105: Identify the operation event as a long-press event if it is determined that the operation duration is longer than 0.3 s.

For example, if the operation duration of the user operation triggered on the rotation control is longer than 0.3 s, it indicates that the user operation is a long-press operation, and the user operation is identified as a second trigger operation. The second trigger operation is configured for rotating the article by a dynamic rotation angle.

Operation 1106: Display a rotation scale.

For example, a rotation scale area is displayed in response to the long-press operation. The rotation scale area includes a scale bar and a scale indication element. A position of the scale indication element on the scale bar indicates a current rotation angle of the article in the virtual scene.

Operation 1107: Determine a direction of a horizontal coordinate movement amount of 1 px.

For example, when the rotation control is long-pressed, a user triggers a slide operation joining the long-press operation.

A horizontal coordinate movement amount of the slide operation is calculated. When sliding is performed in a left-right horizontal direction, a sliding distance is the horizontal coordinate movement amount. When sliding is performed in a left-right non-horizontal direction, only the horizontal coordinate movement amount is calculated. In addition, a direction of each horizontal coordinate movement amount of 1 px is identified. A computer device identifies the direction of each horizontal coordinate movement amount of 1 px in real time, and changes a rotation direction of the article based on the direction of each horizontal coordinate movement amount of 1 px.

Operation 1108: Rotate the article by 1° clockwise if it is determined that the direction of the horizontal coordinate movement amount of 1 px is the left.

When a horizontal coordinate moves leftwards, sliding leftwards is identified. Each time the horizontal coordinate moves by 1 px, the article is rotated by 1° clockwise in the horizontal direction.

Operation 1109: Rotate the article by 1° counterclockwise if it is determined that the direction of the horizontal coordinate movement amount of 1 px is the right.

When the horizontal coordinate moves rightwards, sliding rightwards is identified. Each time the horizontal coordinate moves by 1 px, the article is rotated by 1° counterclockwise in the horizontal direction.

Operation 1110: Determine whether a hand is loosened.

For example, it is determined whether a finger of the user leaves a screen of the computer device.

Operation 1111: End rotation if it is determined that the hand is loosened.

For example, if it is determined that the finger of the user leaves the screen of the computer device, rotation is ended. If it is determined that the finger of the user does not leave the screen of the computer device, operation 1107 is performed: Determine the direction of the horizontal coordinate movement amount of 1 px.

In some embodiments, different virtual elements correspond to different rotation units. In this case, when rotation adjustment is performed on the first virtual element, whether a trigger operation conforms to a rotation condition of the virtual element needs to be determined. The rotation condition is an angle requirement for rotating the virtual element. An example in which the first trigger operation is implemented as a tap operation and the second trigger operation is implemented as a long-press operation and a slide operation is used below for description.

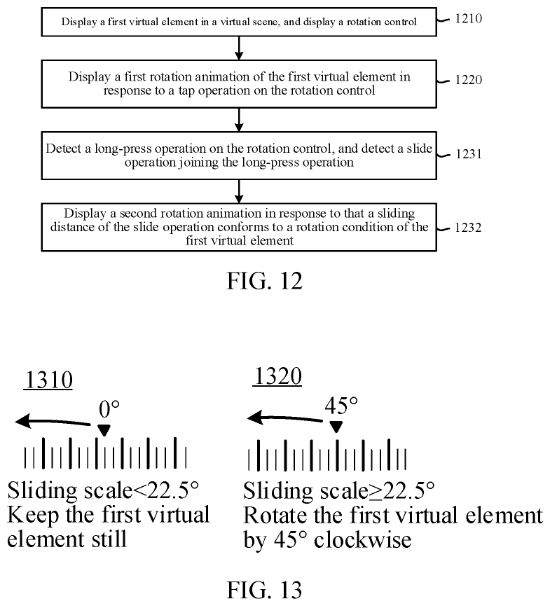

For example, referring to FIG. 12, the embodiment shown in FIG. 3 or FIG. 4 may alternatively be implemented as a method in FIG. 12. The method includes operation 1210 to operation 1232.

Operation 1210: Display a first virtual element in a virtual scene, and display a rotation control.

The rotation control is configured to adjust a rotation status of the first virtual element in the virtual scene.

For example, in the virtual scene, different virtual elements correspond to different rotation units. For example, if a rotation unit of the first virtual element is 1°, it indicates that the first virtual element can be rotated by using 1° as a unit. If the rotation unit of the first virtual element is 45°, it indicates that the first virtual element can be rotated only by using 45° as a unit, which means that the first virtual element is rotated by an angle like 45°, 90°, or 135°, rather than any angle.

Operation 1220: Display a first rotation animation of the first virtual element in response to a tap operation on the rotation control. In other words, the computer device renders the first rotation animation in response to the tap operation on the rotation control.

The first rotation animation includes an animation effect that the first virtual element is rotated by a preset rotation angle.

In one embodiment, the first rotation animation of the first virtual element is displayed in response to the tap operation on the rotation control and that the tap operation conforms to a rotation condition of the first virtual element.

For example, assuming that the rotation unit of the first virtual element is 1°, when the preset rotation angle is a multiple of 1° (for example, 1° or 2°), it is determined that the tap operation conforms to an angle requirement corresponding to the first virtual element, and the first virtual element is rotated by the preset rotation angle. Alternatively, if the rotation unit of the first virtual element is 1°, for any preset rotation angle, the tap operation conforms to the angle requirement corresponding to the first virtual element, and the first virtual element is rotated by the preset rotation angle.

Assuming that the rotation unit of the first virtual element is a degree number other than 1°, for example, 45°, when the preset rotation angle is a multiple of 45° (for example, 45° or 90°), it is determined that the tap operation conforms to the rotation condition of the first virtual element, and the first virtual element is rotated by the preset rotation angle. When the preset rotation angle is not the multiple of 45°, for example, the preset rotation angle is 15° and 15°<22.5°, the tap operation does not conform to the rotation condition of the first virtual element, and rotation is not performed. When the preset rotation angle is 33° and 33°>22.5°, the tap operation conforms to the rotation condition of the first virtual element, but rotation is not performed by the preset rotation angle 33° but is performed by 45°.

Operation 1231: Detect a long-press operation on the rotation control, and detect a slide operation joining the long-press operation.

For example, in response to that tap-and-press duration of a tap-and-press operation on the rotation control is longer than a duration threshold, it is determined that the tap-and-press operation is a long-press operation. After the long-press operation on the rotation control is detected, a user may loosen a hand (that is, a finger leaves a screen). After the user loosens the hand, if the user performs a slide operation on the screen in preset duration, the slide operation is valid, that is, the first virtual element may be controlled to be rotated. If the user performs a slide operation on the screen after the preset duration, the slide operation is invalid, that is, the first virtual element cannot be controlled to be rotated.

Alternatively, after the long-press operation on the rotation control is detected, if the user directly performs a slide operation on the screen without loosening the hand (that is, the finger does not leave the screen), the slide operation is valid, that is, the first virtual element may be controlled to be rotated.

Operation 1232: Display a second rotation animation in response to that a sliding distance of the slide operation conforms to the rotation condition of the first virtual element. In other words, the computer device renders the second rotation animation while the slide operation is being performed and before being ended.

In one embodiment, the second rotation animation is displayed in response to that a horizontal coordinate movement amount of the slide operation conforms to the rotation condition of the first virtual element.

For example, each time the horizontal coordinate movement amount of the slide operation is increased by 1 pixel (px), a rotation angle of the first virtual element is increased by a preset angle. For example, if the preset angle is 1°, when the horizontal coordinate movement amount is 3 px, the corresponding angle is 3°. If the preset angle is 3°, when the horizontal coordinate movement amount is 3 px, the corresponding angle is 9°.

Assuming that the rotation unit of the first virtual element is 1°, when the angle corresponding to the horizontal coordinate movement amount is a multiple of 1° (for example, 1° or 2°), it is determined that the slide operation conforms to the rotation condition of the first virtual element, and the first virtual element is rotated by the angle corresponding to the horizontal coordinate movement amount. Alternatively, if the rotation unit of the first virtual element is 1°, any slide operation conforms to the rotation condition of the first virtual element, and the first virtual element is rotated by the angle corresponding to the horizontal coordinate movement amount of the slide operation.

For an article having a special rotation rule, when being pressed and rotated, rotation needs to be performed in a manner conforming to the special rule. For example, if the first virtual element can be rotated only by using 45° as a unit, it is specified that the first virtual element is rotated in response to the slide operation only when a rotation angle indicated by the sliding distance is greater than or equal to 22.5°.

Assuming that the rotation unit of the first virtual element is a degree number other than 1°, for example, 45°, when the angle corresponding to the horizontal coordinate movement amount is a multiple of 45° (for example, 45° or 90°), it is determined that the slide operation conforms to the rotation condition of the first virtual element, and the first virtual element is rotated by the angle corresponding to the horizontal coordinate movement amount. When the angle corresponding to the horizontal coordinate movement amount is not the multiple of 45°, for example, the angle corresponding to the horizontal coordinate movement amount is 15° and 15°<22.5° (half of 45°), the slide operation does not conform to the rotation condition of the first virtual element, and rotation is not performed. When the angle corresponding to the horizontal coordinate movement amount is 33° and 33°>22.5°, the slide operation conforms to the rotation condition of the first virtual element, but rotation is not performed by the angle 33° corresponding to the horizontal coordinate movement amount but is performed by 45°.

FIG. 13 is a schematic diagram of a rotation scale. As shown in 1310 in FIG. 13, if the rotation control is long-pressed and then slid leftwards, a scale bar moves leftwards by one grid. When a sliding angle currently indicated by the slide operation is 15° by which clockwise rotation is performed, that is, less than 22.5°, the first virtual element is not rotated, and a scale indication element is still displayed at 0°. As shown in 1320 in FIG. 13, if the rotation control is long-pressed and then slid leftwards, the scale bar moves leftwards by three grids. When the sliding angle currently indicated by the slide operation is 45° by which clockwise rotation is performed, that is, greater than 22.5°, the first virtual element is rotated by 45° clockwise, and the scale indication element is displayed at 45°.

In conclusion, according to the virtual element display method provided in this embodiment of this application, different virtual elements correspond to different rotation units. In this case, when rotation adjustment is performed on a first virtual element, whether a trigger operation conforms to a rotation condition of the virtual element needs to be determined. A corresponding rotation operation is performed on the virtual element only when a requirement is conformed to. This implements a high-precision, flexible, and efficient rotation editing operation, reduces computer resource consumption, and adapts to requirements of diversified application scenarios.

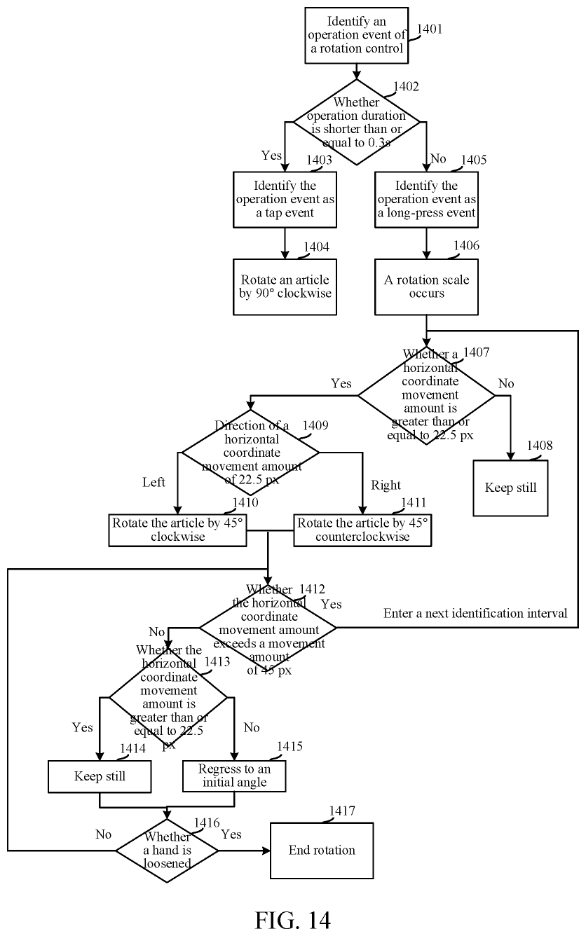

For example, FIG. 14 is an implementation flowchart of a rotation control according to an exemplary embodiment of this application.

Operation 1401: Identify an operation event of the rotation control.

For example, a scene editing interface of a game is displayed, and a virtual scene is edited on the scene editing interface, for example, an article (for example, a virtual character, a virtual vehicle, or a virtual building) is added to the virtual scene. After the article is added, an editing operation like a rotation operation, a movement operation, or a zoom operation, may be performed on the article after the article is selected. The following uses the rotation operation as an example for description.

In this embodiment of this application, the article that is currently added to the virtual scene and that is selected for editing is an article having a special rotation rule, and the article can be rotated only by using 45° as a unit.

In one embodiment, the rotation control is displayed on the scene editing interface, to implement the rotation operation. If a user operation is triggered on the rotation control, the user operation is identified, to determine operation duration of the user operation.

Operation 1402: Determine whether the operation duration is shorter than or equal to 0.3 s.

For example, it is determined whether the operation duration of the user operation triggered on the rotation control is shorter than or equal to 0.3 s.

Operation 1403: Identify the operation event as a tap event if it is determined that the operation duration is shorter than or equal to 0.3 s.

For example, if the operation duration of the user operation triggered on the rotation control is shorter than or equal to 0.3 s, it indicates that the user operation is a tap operation, and the user operation is identified as a first trigger operation. The first trigger operation is configured for rotating an article by a preset rotation angle.

Operation 1404: Rotate the article by 90° clockwise.

For example, in response to the tap operation, the article is rotated by the preset rotation angle (90°) in a preset rotation direction (clockwise), that is, the article is rotated by 90° clockwise.

Operation 1405: Identify the operation event as a long-press event if it is determined that the operation duration is longer than 0.3 s.

For example, if the operation duration of the user operation triggered on the rotation control is longer than 0.3 s, it indicates that the user operation is a long-press operation, and the user operation is identified as a second trigger operation. The second trigger operation is configured for rotating an article by a dynamic rotation angle.

Operation 1406: Display a rotation scale.

For example, a rotation scale area is displayed in response to the long-press operation. The rotation scale area includes a scale bar and a scale indication element. A position of the scale indication element on the scale bar indicates a current rotation angle of the article in the virtual scene.

Operation 1407: Determine whether a horizontal coordinate movement amount is greater than or equal to 22.5 px.

For example, when the rotation control is long-pressed, a user triggers a slide operation joining the long-press operation. It is determined whether a horizontal coordinate movement amount corresponding to the slide operation is greater than or equal to 22.5 px. When sliding is performed in a left-right horizontal direction, a sliding distance is the horizontal coordinate movement amount. When sliding is performed in a left-right non-horizontal direction, only the horizontal coordinate movement amount is calculated.

Operation 1408: Keep still if it is determined that the horizontal coordinate movement amount is less than 22.5 px.

For example, if the horizontal coordinate movement amount corresponding to the slide operation is less than 22.5 px, the article is kept still, that is, the article is not rotated.

Operation 1409: Determine a direction of a movement amount of 22.5 px if it is determined that the horizontal coordinate movement amount is greater than or equal to 22.5 px.

For example, if the horizontal coordinate movement amount corresponding to the slide operation is greater than or equal to 22.5 px, the direction of the movement amount of 22.5 px is determined.

Operation 1410: Rotate the article by 45° clockwise if it is determined that the direction of the movement amount of 22.5 px is the left.

For example, if it is determined that the direction of the movement amount of 22.5 px is the left, the article is rotated by 45° clockwise in the horizontal direction.

Operation 1411: Rotate the article by 45° counterclockwise if it is determined that the direction of the horizontal coordinate movement amount of 22.5 px is the right.

For example, if it is determined that the direction of the movement amount of 22.5 px is the right, the article is rotated by 45° counterclockwise in the horizontal direction.

Operation 1412: Determine whether the horizontal coordinate movement amount exceeds a movement amount of 45 px.

For example, if the user continues to slide (that is, does not loosen a hand), it is determined whether a horizontal coordinate movement amount corresponding to the slide operation in this case is greater than 45 px. If it is determined that the horizontal coordinate movement amount is greater than the movement amount of 45 px, a next identification interval is entered, that is, operation 1407 is performed: Determine whether a movement amount beyond the movement amount of 45 px is greater than or equal to 22.5 px. For example, if a current horizontal coordinate movement amount is 50 px, it is determined whether (50-45) px is greater than or equal to 22.5 px.

Operation 1413: If it is determined that the horizontal coordinate movement amount does not exceed the movement amount of 45 px, determine whether the horizontal coordinate movement amount is greater than or equal to 22.5 px.

If it is determined that the horizontal coordinate movement amount is less than or equal to the movement amount of 45 px, it is determined whether the current horizontal coordinate movement amount is greater than or equal to 22.5 px.

Operation 1414: Keep still if it is determined that the horizontal coordinate movement amount is greater than or equal to 22.5 px.

If it is determined that the horizontal coordinate movement amount is still greater than or equal to the movement amount of 22.5 px, the article is kept still.

Operation 1415: Regress to an initial angle if it is determined that the horizontal coordinate movement amount is less than 22.5 px.

If it is determined that the horizontal coordinate movement amount is less than the movement amount of 22.5 px in this case, the article is regressed to the initial angle, that is, an angle before rotation.

Operation 1416: Determine whether the hand is loosened.

For example, it is determined whether a finger of the user leaves a screen of a computer device.

Operation 1417: End rotation if it is determined that the hand is loosened.

For example, if it is determined that the finger of the user leaves the screen of the computer device, rotation is ended. If it is determined that the finger of the user does not leave the screen of the computer device, operation 1412 is performed: Determine whether the current horizontal coordinate movement amount exceeds the movement amount of 45 px.

In conclusion, in a construction game, to place an article at a proper position and angle, a user needs to use a rotation function at an exceedingly high frequency. According to the virtual element display method provided in this embodiment of this application, a rotation operation of the virtual element is simplified, and rapid rotation and precise rotation functions are integrated on one control, so that a plurality of rotation operations on the virtual element can be completed on one control of one interface. This optimizes building experience in the game, and improves activeness and retention intention of the user in a building mode, thereby achieving a more positive effect on game data.

The following describes a procedure of the virtual element display method provided in this application by using an example in which the editing control is implemented as a zoom control.

Operation 1: Display a first virtual element in a virtual scene, and display a zoom control.

The zoom control is configured to adjust a zoom ratio of the first virtual element in the virtual scene.

In one embodiment, the zoom control may be a button, a slide bar, or an area that can be touched. The zoom control may alternatively be implemented as the first virtual element.

Operation 2: Display a first zoom animation of the first virtual element in response to a tap operation on the zoom control.

In one embodiment, the first zoom animation includes an animation effect that the first virtual element is zoomed out/in by a preset zoom ratio. For example, when a tap event is detected, the first zoom animation of the first virtual element is displayed. The first zoom animation may gradually become larger or gradually become smaller.

If a current zoom ratio of the first virtual element is greater than the preset zoom ratio, the first virtual element in the first zoom animation gradually becomes smaller. If the current zoom ratio of the first virtual element is less than the preset zoom ratio, the first virtual element in the first zoom animation gradually becomes larger.

Operation 3: In response to a multi-point touch operation on the zoom control, display a second zoom animation of the first virtual element in real time in tandem with the multi-point touch operation.

The second zoom animation includes an animation effect that the first virtual element is zoomed out/in by a dynamic zoom ratio corresponding to the multi-point touch operation.

For example, the multi-touch operation is a trigger operation of two or more fingers on a screen. The multi-touch operation may be implemented as a two-finger open operation. In other words, two fingers are put on the screen and then the fingers are slid outwards. The two-finger open operation is triggered, and a computer device displays the second zoom animation configured for increasing the zoom ratio, that is, zooming in the first virtual element.

Alternatively, the two-finger touch operation may be implemented as a two-finger close operation. In other words, a user puts the two fingers on the screen, and then slides the fingers inwards, that is, moves the fingers towards each other. The two-finger close operation is triggered, and the computer device displays the second zoom animation configured for reducing the zoom ratio, that is, zooming out the first virtual element.

The computer device may determine intention of the user by detecting initial positions and moving tracks of touch points respectively corresponding to the two fingers, and trigger the corresponding second zoom animation based on the intention.

The following describes a procedure of the virtual element display method provided in this application by using an example in which the editing control is implemented as a level adjustment control.

Operation 1: Display a first virtual element in a virtual scene, and display a level adjustment control.

The level adjustment control is configured to adjust a display level of the first virtual element in the virtual scene. In one embodiment, the level adjustment control may be a button, a slide bar, or an area that can be touched. The level adjustment control may alternatively be implemented as the first virtual element.

For example, levels determine a stack sequence of elements in a scene, that is, specific elements are blocked, and specific elements block other elements.

Operation 2: Display a first level adjustment animation of the first virtual element in response to a tap operation on the level adjustment control.

In one embodiment, the first level adjustment animation includes an animation effect that level adjustment at a preset level is performed on the first virtual element. When a user taps on the level adjustment control, a computer device presents a change of the first virtual element in level in response to such an operation, that is, the first virtual element is moved to the preset level.

Operation 3: In response to a slide operation on the level adjustment control, display a second level adjustment animation of the first virtual element in real time in tandem with the slide operation.

The second level adjustment animation includes an animation effect that level adjustment at a dynamic level corresponding to the slide operation is performed on the first virtual element.

For example, different from the tap operation, the slide operation allows the user to adjust a level of a virtual element continuously and dynamically. The computer device presents a continuous change of the level of the element in real time in response to the slide operation. In one embodiment, a new level is calculated in real time based on a sliding direction and a sliding distance of the slide operation, and the level of the first virtual element is adjusted.

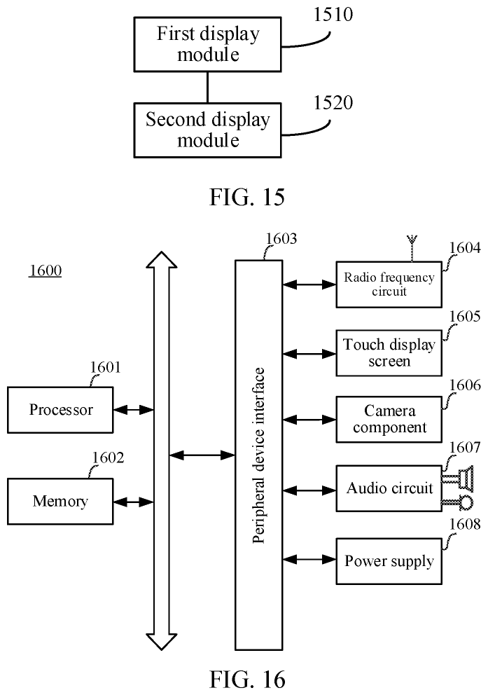

For example, FIG. 15 is a structural block diagram of a virtual element display apparatus according to an exemplary embodiment of this application. The apparatus includes the following modules:

a first display module 1510, configured to display a first virtual element in a virtual scene, and display an editing control, the editing control being configured to edit the first virtual element in the virtual scene; and

a second display module 1520, configured to display a first transformation animation of the first virtual element in response to a first trigger operation on the editing control, the first transformation animation including an animation effect that the first virtual element is transformed by a preset transformation amplitude,

the second display module 1520 being further configured to display, in response to a second trigger operation on the editing control, a second transformation animation of the first virtual element in real time in tandem with the second trigger operation, the second transformation animation including an animation effect that the first virtual element is transformed continuously corresponding to the second trigger operation, and the first trigger operation being different from the second trigger operation.

In some embodiments, the editing control includes a rotation control, and the rotation control is configured to control the first virtual element to rotate in the virtual scene; and the second display module 1520 is further configured to display a first rotation animation of the first virtual element in response to the first trigger operation on the rotation control, the first rotation animation including an animation effect that the first virtual element is rotated by a preset rotation angle in a first rotation direction.

In some embodiments, the first rotation direction is a preset rotation direction; or the first rotation direction is a rotation direction determined based on a trigger position of the first trigger operation on the rotation control.

In some embodiments, the first virtual element corresponds to a plurality of rotation axes; and the second display module 1520 is further configured to:
after the first trigger operation on the rotation control is detected, in response to that the first trigger operation is ended, display the first rotation animation based on a trigger stage at which the first trigger operation is ended, the trigger stage at which the first trigger operation is ended corresponding to a first rotation axis, and the first rotation animation including an animation effect that the first virtual element is rotated around the first rotation axis; and
the first trigger operation including a plurality of trigger stages, and the plurality of trigger stages respectively corresponding to different rotation axes.

In some embodiments, the first display module 1510 is configured to:
display a first setting area, the first setting area being configured for configuring a transformation amplitude corresponding to the first trigger operation; and
configure the preset transformation amplitude for the first trigger operation in response to an amplitude configuration operation on the first trigger operation in the first setting area.

In some embodiments, the second display module 1520 is further configured to:

after a long-press operation on the editing control is detected, in response to a slide operation joining the long-press operation, display the second transformation animation in real time in tandem with the slide operation, the second transformation animation including an animation effect that the first virtual element is transformed continuously corresponding to the slide operation.

In some embodiments, the editing control includes the rotation control, and the rotation control is configured to control the first virtual element to rotate in the virtual scene; and the second display module 1520 is further configured to: after the long-press operation on the editing control is detected, in response to the slide operation joining the long-press operation, displaying a second rotation animation in real time in tandem with the slide operation, the second rotation animation including an animation effect that the first virtual element is rotated by a dynamic rotation angle in a second rotation direction, and the dynamic rotation angle being a rotation angle determined based on a slide parameter corresponding to the slide operation.

In some embodiments, the second rotation direction is a preset rotation direction; or the second rotation direction is a rotation direction determined based on a trigger position of the second trigger operation on the rotation control, and the second trigger operation includes the long-press operation and the slide operation.

In some embodiments, the first virtual element corresponds to the plurality of rotation axes; and the second display module 1520 is further configured to:
after the long-press operation on the editing control is detected, in response to the slide operation joining the long-press operation, display, based on long-press duration of the long-press operation, the second rotation animation in real time in tandem with the slide operation, the long-press duration of the long-press operation corresponding to a second rotation axis, and the second rotation animation including an animation effect that the first virtual element is rotated around the second rotation axis.

In some embodiments, the second display module 1520 is further configured to:
after the long-press operation on the editing control is detected, in response to the slide operation joining the long-press operation, display a representation form of the rotation control as a representation form corresponding to the long-press duration, the representation form corresponding to the long-press duration indicating the second rotation axis; and
the rotation control including a plurality of representation forms, and the plurality of representation forms respectively indicating different rotation axes.

In some embodiments, the second display module 1520 is further configured to:
after the slide operation is detected, display the second rotation animation in real time in tandem with the slide operation in response to that a sliding distance of the slide operation conforms to a rotation condition of the first virtual element.

In some embodiments, the second display module 1520 is further configured to:
display amplitude indication information in response to the long-press operation, the amplitude indication information indicating a transformation amplitude corresponding to the first virtual element; and
display the second transformation animation and an information change animation in response to the slide operation joining the long-press operation, the information change animation including an animation effect that the amplitude indication information is updated based on the dynamic transformation amplitude corresponding to the slide operation.

In some embodiments, the second display module 1520 is further configured to:
after the long-press operation on the editing control is detected, display the second transformation animation in response to a first tap operation on a first position in the virtual scene and a second tap operation on a second position in the virtual scene, the dynamic transformation amplitude being determined based on a distance between the first position and the second position.

In some embodiments, the second display module 1520 is further configured to:
display a second setting area in response to the long-press operation on the editing control, the second setting area including an amplitude adjustment control, and the amplitude adjustment control being configured to adjust the transformation amplitude of the first virtual element; and
move the amplitude adjustment control in the second setting area in response to a movement operation on the amplitude adjustment control, to display the second transformation animation, the dynamic transformation amplitude being determined based on a position of the amplitude adjustment control in the second setting area.

In some embodiments, the virtual scene includes a second virtual element, and the first virtual element and the second virtual element have an association relationship; and the second display module 1520 is further configured to display the first transformation animation in response to the first trigger operation on the editing control, the first transformation animation including an animation effect that the first virtual element and the second virtual element are synchronously transformed by the preset transformation amplitude.

In some embodiments, the first display module 1510 is further configured to display, in response to an addition operation on the first virtual element, the first virtual element in the virtual scene, and display the editing control.

In some embodiments, the second display module 1520 is further configured to: after a first tap-and-press operation on the editing control is detected, display the first transformation animation in response to that the first tap-and-press operation is ended and operation duration of the first tap-and-press operation is shorter than or equal to a duration threshold.

In some embodiments, the second display module 1520 is further configured to: after a second tap-and-press operation on the editing control is detected, display the second transformation animation in real time in tandem with the second tap-and-press operation in response to that operation duration of the second tap-and-press operation is longer than the duration threshold.

In some embodiments, the second display module 1520 is further configured to obtain operation duration of a plurality of target tap-and-press operations generated by the first account in a historical time period, the plurality of target tap-and-press operations being historical tap-and-press operations being the first trigger operation, and operation duration of the target tap-and-press operation being duration from a start moment to an end moment of the target tap-and-press operation; and update the duration threshold based on the operation duration of the plurality of target tap-and-press operations.

In conclusion, according to the virtual element display apparatus provided in this embodiment of this application, a user may perform customized editing on a virtual element in a virtual scene by triggering an editing control. When a first trigger operation is performed on the editing control, the virtual element is transformed by a preset transformation amplitude, and the user does not need to manually set or adjust a transformation amplitude, to implement rapid transformation control on the virtual element. When a second trigger operation is performed on the editing control, the virtual element is transformed following the second trigger operation by a dynamic transformation amplitude corresponding to the second trigger operation. Therefore, the second trigger operation is controlled, so that the transformation amplitude of the virtual element can be precisely controlled, to implement precise transformation control on the virtual element. Therefore, rapid transformation control and precise transformation control on the virtual element are integrated on one editing control, so that the user can complete a plurality of types of transformation control on the virtual element on one editing control. This improves flexibility of performing transformation control on the virtual element, and simplifies operations for implementing the plurality of types of transformation control, thereby improving operation efficiency of the user for controlling the virtual element to be transformed, and reducing waste of computer operation resources.

The virtual element display apparatus provided in the foregoing embodiments is illustrated with an example of division of the foregoing functional modules. In actual application, the functions may be allocated to and completed by different functional modules based on requirements, that is, the internal structure of the device is divided into different functional modules, to implement all or some of the functions described above. In addition, the virtual element display apparatus provided in the foregoing embodiments belongs to the same concept as the embodiments of the virtual element display method. For a specific implementation process of the apparatus, reference is made to the method embodiments. Details are not described herein again.

FIG. 16 is a structural block diagram of a computer device according to an exemplary embodiment of this application.

A computer device 1600 may be a portable mobile terminal, for example, a smartphone, a tablet computer, a moving picture experts group audio layer III (MP3) player, or a moving picture experts group audio layer IV (MP4) player. The computer device 1600 may also be referred to as another names such as user equipment or a portable terminal.

The computer device 1600 includes a processor 1601 and a memory 1602.

The processor 1601 may include one or more processing cores, such as a 4-core processor or an 8-core processor. The processor 1601 may be implemented by using at least one hardware form of a digital signal processor (DSP), a field programmable gate array (FPGA), and a programmable logic array (PLA). The processor 1601 may alternatively include a main processor and a coprocessor. The main processor is configured to process data in an active state, also referred to as a central processing unit (CPU). The coprocessor is a low-power consumption processor configured to process data in a standby state.

The memory 1602 may include one or more computer-readable storage media. The computer-readable storage medium may be tangible and non-transient. The memory 1602 may also include a high-speed random access memory, as well as non-volatile memory, such as one or more disk storage devices and flash storage devices. In some embodiments, a non-transitory computer-readable storage medium in the memory 1602 is configured to store at least one instruction, the at least one instruction being configured to be executed by the processor 1601 to implement the virtual element display method provided in the embodiments of this application.

In some embodiments, the computer device 1600 further includes a peripheral device interface 1603 and at least one peripheral device. Specifically, the peripheral device includes at least one of a radio frequency circuit 1604, a touch display screen 1605, a camera component 1606, an audio circuit 1607, and a power supply 1608.

A person skilled in the art may understand that the structure shown in FIG. 16 does not constitute any limitation on the computer device 1600, and the computer device may include more components or fewer components than those shown in the figure, or some components may be combined, or a different component deployment may be used.

In an exemplary embodiment, this application provides a chip, including a programmable logic circuit and/or program instructions. When the chip runs on a computer device, the chip is configured to implement the virtual element display method provided in the foregoing method embodiments.

This application further provides a computer-readable storage medium, having a computer program stored therein, the computer program being loaded and executed by a processor to implement the virtual element display method provided in the foregoing method embodiments.

This application provides a computer program product or a computer program, including computer instructions, the computer instructions being stored in a computer-readable storage medium. A processor of a computer device reads the computer instructions from the computer-readable storage medium and executes the computer instructions, to cause the computer device to perform the virtual element display method provided in the foregoing method embodiments.

The sequence numbers of the foregoing embodiments of this application are only for description purpose, and are not intended to indicate priorities of the embodiments.

A person of ordinary skill in the art may understand that all or some of the steps of the embodiments may be implemented by hardware or a program instructing related hardware. The program may be stored in a computer-readable storage medium. The computer-readable storage medium may be a read-only memory, a magnetic disk, an optical disc, or the like.

The foregoing descriptions are only exemplary embodiments of this application, but are not intended to limit this application. Any modification, equivalent replacement, or improvement made within the spirit and principle of this application shall fall within the protection scope of this application.

What is claimed is:

1. A virtual element display method, performed by a computer device, the method comprising:
displaying a virtual scene including a first virtual element and an editing control in a user interface, the editing control being configured to edit the first virtual element in the virtual scene;
in response to a first trigger operation on the editing control, rendering a first transformation animation of the first virtual element after the first trigger operation, the first transformation animation comprising an animation effect that the first virtual element is transformed by a preset transformation amplitude; and
in response to a second trigger operation on the editing control, rendering a second transformation animation of the first virtual element in real time in tandem with the second trigger operation, the second transformation animation comprising an animation effect that the first virtual element is transformed continuously corresponding to the second trigger operation, and the first trigger operation being different from the second trigger operation.

2. The method according to claim 1, wherein the editing control comprises a rotation control configured to control the first virtual element to rotate in the virtual scene; and
the rendering the first transformation animation of the first virtual element comprises:
rendering a first rotation animation of the first virtual element after the first trigger operation on the rotation control, the first rotation animation comprising an animation effect that the first virtual element is rotated by a preset rotation angle in a first rotation direction.

3. The method according to claim 2, wherein the first rotation direction is determined based on a trigger position of the first trigger operation on the rotation control.

4. The method according to claim 2, wherein the first virtual element has a plurality of rotation axes and the first trigger operation comprising a plurality of trigger stages respectively corresponding to different rotation axes; and
the rendering the first transformation animation of the first virtual element comprises:
determining a trigger stage at which the first trigger operation is ended and a first rotation axis corresponding to the trigger stage; and
rendering an animation in which the first virtual element is rotated around the first rotation axis.

5. The method according to claim 1, wherein the method further comprises:
before rendering the first transformation animation of the first virtual element:
displaying a first setting area, the first setting area being configured for configuring a transformation amplitude corresponding to the first trigger operation; and
configuring the preset transformation amplitude for the first trigger operation in response to an amplitude configuration operation on the first trigger operation in the first setting area.

6. The method according to claim 1, wherein the rendering the second transformation animation of the first virtual element in real time in tandem with the second trigger operation comprises:
displaying the second transformation animation in real time in tandem with a slide operation after a long-press operation on the editing control, the second transformation animation comprising an animation effect that the first virtual element is transformed continuously corresponding to the slide operation.

7. The method according to claim 1, wherein the rendering the second transformation animation of the first virtual element in real time in tandem with the second trigger operation comprises:
rendering the second transformation animation in response to a first tap operation on a first position in the virtual scene and a second tap operation on a second position in the virtual scene after a long-press operation on the editing control, the dynamic transformation amplitude being determined based on a distance between the first position and the second position.

8. The method according to claim 1, wherein the rendering the second transformation animation of the first virtual element in real time in tandem with the second trigger operation comprises:
displaying a second setting area in response to a long-press operation on the editing control, the second setting area comprising an amplitude adjustment control, and the amplitude adjustment control being configured to adjust the transformation amplitude of the first virtual element; and
moving the amplitude adjustment control in the second setting area in response to a movement operation on the amplitude adjustment control, to display the second transformation animation, the dynamic transformation amplitude being determined based on a position of the amplitude adjustment control in the second setting area.

9. The method according to claim 1, wherein the virtual scene comprises a second virtual element, and the first virtual element and the second virtual element have an association relationship; and
the rendering the first transformation animation of the first virtual element comprises:
rendering an in which the first virtual element and the second virtual element are synchronously transformed by the preset transformation amplitude.

10. The method according to claim 1, wherein the rendering the first transformation animation of the first virtual element comprises:
rendering the first transformation animation after a first tap-and-press operation is ended and the first tap-and-press operation has an operation duration shorter than or equal to a duration threshold.

11. The method according to claim 1, wherein the rendering the second transformation animation of the first virtual element in real time in tandem with the second trigger operation comprises:
rendering the second transformation animation in real time in tandem with a second tap-and-press operation and the second tap-and-press operation has an operation duration longer than a duration threshold.

12. A computer device, comprising a processor and a memory, the memory having at least one program stored therein, the at least one program being loaded and executed by the processor to implement a virtual element display method including:
displaying a virtual scene including a first virtual element and an editing control in a user interface, the editing control being configured to edit the first virtual element in the virtual scene;
in response to a first trigger operation on the editing control, rendering a first transformation animation of the first virtual element after the first trigger operation, the first transformation animation comprising an animation effect that the first virtual element is transformed by a preset transformation amplitude; and
in response to a second trigger operation on the editing control, rendering a second transformation animation of the first virtual element in real time in tandem with the second trigger operation, the second transformation animation comprising an animation effect that the first virtual element is transformed continuously corresponding to the second trigger operation, and the first trigger operation being different from the second trigger operation.

13. The computer device according to claim 12, wherein the editing control comprises a rotation control configured to control the first virtual element to rotate in the virtual scene; and
the rendering the first transformation animation of the first virtual element comprises:
rendering a first rotation animation of the first virtual element after the first trigger operation on the rotation control, the first rotation animation comprising an animation effect that the first virtual element is rotated by a preset rotation angle in a first rotation direction.

14. The computer device according to claim 12, wherein the method further comprises:
before rendering the first transformation animation of the first virtual element:
displaying a first setting area, the first setting area being configured for configuring a transformation amplitude corresponding to the first trigger operation; and
configuring the preset transformation amplitude for the first trigger operation in response to an amplitude configuration operation on the first trigger operation in the first setting area.

15. The computer device according to claim 12, wherein the rendering the second transformation animation of the first virtual element in real time in tandem with the second trigger operation comprises:
displaying the second transformation animation in real time in tandem with a slide operation after a long-press operation on the editing control, the second transformation animation comprising an animation effect that the first virtual element is transformed continuously corresponding to the slide operation.

16. The computer device according to claim 12, wherein the rendering the second transformation animation of the first virtual element in real time in tandem with the second trigger operation comprises:
rendering the second transformation animation in response to a first tap operation on a first position in the virtual scene and a second tap operation on a second position in the virtual scene after a long-press operation on the editing control, the dynamic transformation amplitude being determined based on a distance between the first position and the second position.

17. The computer device according to claim 12, wherein the rendering the second transformation animation of the first virtual element in real time in tandem with the second trigger operation comprises:
displaying a second setting area in response to a long-press operation on the editing control, the second setting area comprising an amplitude adjustment control, and the amplitude adjustment control being configured to adjust the transformation amplitude of the first virtual element; and
moving the amplitude adjustment control in the second setting area in response to a movement operation on the amplitude adjustment control, to display the second transformation animation, the dynamic transformation amplitude being determined based on a position of the amplitude adjustment control in the second setting area.

18. The computer device according to claim 12, wherein the virtual scene comprises a second virtual element, and the first virtual element and the second virtual element have an association relationship; and
the rendering the first transformation animation of the first virtual element comprises:
rendering an in which the first virtual element and the second virtual element are synchronously transformed by the preset transformation amplitude.

19. The computer device according to claim 12, wherein the rendering the first transformation animation of the first virtual element comprises:
rendering the first transformation animation after a first tap-and-press operation is ended and the first tap-and-press operation has an operation duration shorter than or equal to a duration threshold.

20. A non-transitory computer-readable storage medium, having at least one program stored therein, the at least one program being loaded and executed by a processor of a computer device and causing the computer device to implement a virtual element display method including:
displaying a virtual scene including a first virtual element and an editing control in a user interface, the editing control being configured to edit the first virtual element in the virtual scene;
in response to a first trigger operation on the editing control, rendering a first transformation animation of the first virtual element after the first trigger operation, the first transformation animation comprising an animation effect that the first virtual element is transformed by a preset transformation amplitude; and
in response to a second trigger operation on the editing control, rendering a second transformation animation of the first virtual element in real time in tandem with the second trigger operation, the second transformation animation comprising an animation effect that the first virtual element is transformed continuously corresponding to the second trigger operation, and the first trigger operation being different from the second trigger operation.
